(19) United States
(12) Patent Application Publication
(10) Pub. No.: US 2023/0158344 A1
(43) Pub. Date: May 25, 2023

(54) BREATHING MASK WITH PARTICLE FILTER

(71) Applicant: Loewenstein Medical Technology S.A., Luxembourg (LU)

(72) Inventors: Arnold FRERICHS, Buxtehude (DE); Martin BECHTEL, Winsen/Luhe (DE); Martin EIFLER, Glueckstadt (DE); Anja GOTTSCHEWSKI, Hamburg (DE)

(21) Appl. No.: 17/996,871

(22) PCT Filed: Apr. 19, 2021
(86) PCT No.: PCT/EP2021/025143

§ 371 Date: Oct. 21, 2022

(30) Foreign Application Priority Data
Apr. 24, 2020 (DE) 10 2020 002 483.1
Nov. 3, 2020 (DE) 10 2020 006 746.8

(51) Int. Cl. A62B 18/02; A62B 23/02; A62B 18/08; B01D 46/00

(52) U.S. Cl. CPC A62B 18/025; A62B 23/02; A62B 18/08; B01D 46/0028; B01D 46/0005; B01D 2279/65

(57) ABSTRACT

A breathing mask comprising a mask body, a mask bead, a strap holder and a filter device. Mask bead, strap holder and filter device are connected to the mask body and/or are part of the mask body. The breathing mask encloses the nose and mouth of the user, the mask bead partially delimiting a receiving opening for the nose and mouth. The filter device comprises at least one filter receptacle and at least one filter element. The mask bead has a bearing region configured as a sealing lip and is designed such that the breathing mask bears with the sealing lip on the facial skin around nose and mouth and provides a substantially leak-tight seal to respiratory gas. The filter device is at least in part exchangeable and respiratory gas can at least partially flow through it.

Particle-filtering half masks are used as respiratory protection against aerosols made up of solid or liquid, not highly volatile particles. They are tested according to European Standard DIN EN 149 and meet the requirements of this standard. The standard distinguishes the device classes FFP1, FFP2, and FFP3 depending on the retention capacity of the particle filter. The mask typically consists completely of the nonreplaceable filter material. Examples of such masks are disclosed in DE 10 2014 221 311 B3 and DE 20 2013 011 420 U1.

It is necessary to draw a distinction between the above and “half masks or full masks with a particle filter”, which have one or more attachment options for replaceable particle filters. Half masks or full masks with replaceable particle filters according to DE 10 2014 001 937 B3 or DE 20 2014 001 315 U1 are presently quite bulky masks, which are used in particular in the industrial sector and greatly restrict the field of view. Moreover, such masks have at least one valve for inhalation and/or exhalation.

The leak-tightness is decisive for the protective effect of a breathing mask. This results from the filter penetration and the so-called fitting leakage, which arises due to leaks between the sealing line of the mask and the face of the wearer. The protective effect increases from an FFP1 mask (total leakage maximum 22%) via an FFP2 mask (total leakage maximum 8%) to the FFP3 mask (total leakage maximum 2%). The breathing resistance of the mask also rises with the increase in the protective effect. The exhalation resistance is reduced by an exhalation valve. The particle-filtering half mask is thus less burdensome for the wearer and is therefore preferably to be used.

In addition to the filter properties, above all the seal seat of the mask is decisive for the effectiveness of the mask. The specified values with respect to the protective effect only apply for an optimum seat, which is only achieved by careful, correct placement. In general, wearing a well-fitted FFP2 mask represents suitable protection from infectious aerosols, including viruses, since it can be presumed that they are bound to ultrasmall droplets and are thus captured in the filter.

FFP masks are disposable articles and have to be discarded correctly after use for hygienic reasons. When removing the FFP mask, it is to be ensured that the outer surface of the FFP mask does not come into contact with mouth, nose, mucosae, or unprotected hands. Protective gloves are to be replaced immediately after removing the FFP mask and the hands are to be disinfected.

The breathing masks according to the prior art have the following significant disadvantages:
Half or full masks primarily from the industrial sector have bulky constructions and are rather cumbersome to handle, in particular for the filter changing, moreover the production is complicated and expensive.
The FFP masks conceived as disposable articles produce a large quantity of waste to be handled separately.
The masks are conceived as standard sizes or in standard forms with little adaptability. In particular in the case of distinctive facial contours, a tight seat on the face of the user thus cannot be ensured, so that a high level of leakage can result and secure filtering of the respiratory air does not take place.
The breathing masks according to the prior art have an exhalation valve, which is to facilitate the exhalation by the user. This has the disadvantage that, although the user is protected from possible infectious aerosols in the surroundings, if the user himself discharges bacteria or other infectious microorganisms via the respiratory air, these are exhaled unfiltered into the surroundings.

The object of the invention is to provide a breathing mask which, on the one hand, fits on many facial shapes and seals with little leakage, also enables filtering of the exhaled respiratory gas, and has a filter which is easy to change. This object is achieved according to the invention by the proposed breathing mask having the features of claim 1 and the optional filter element having the features of claim 38.

The subject matter of the present invention is a breathing mask, comprising a mask body, a mask bead, at least one strap holder, and at least one filter device, wherein the mask bead, the at least one strap holder, and the at least one filter device are connected to the mask body and/or are part of the mask body, wherein the breathing mask fully encloses the nose and mouth of the user, wherein the mask bead partially delimits a receptacle opening for the nose and mouth of the user. The at least one filter device comprises at least one filter receptacle and at least one filter element here. The mask bead has a contact region embodied as a sealing lip and is conFig.d so that the breathing mask presses against the facial skin around at least the nose and mouth of the user with the sealing lip during use and provides a seal in an essentially respiratory-gas-tight manner. For this purpose, the filter device is at least partially replaceable, and respiratory gas can at least partially flow through it, wherein the filter element comprises at least one filter material.

In some embodiments of the breathing mask, the mask body, the filter receptacle, and the mask bead define a respiratory gas chamber, which is essentially respiratory-gas-tight during use and thus a respiratory gas flow from and/or to the mouth and nose of the user is possible exclusively through the filter device.

In some embodiments of the breathing mask, the mask bead comprises a nasal bridge region, a base region, two side regions, a mask fitting, and a contact region, wherein the nasal bridge region and the base region are spatially separated from one another by the side regions and the nasal bridge region and the base region are each connected to both side regions. Because the two side regions cannot be directly connected to one another and nor can the base region be directly connected to the nasal bridge region, two openings thus result in the mask bead. One of these openings represents the receptacle opening for the mouth and nose of the user. The other opening accordingly faces in the direction of the mask body. Depending on the face of the user, in particular with respect to the size of the nose, the breathing mask can be embodied so that, for example, the nose of the user protrudes into the space of the mask body.

In some embodiments of the breathing mask, the sealing lip describes a curve in cross section starting from the side regions, the nasal bridge region, and the base region and the edge of the sealing lip essentially determines the size of the area of the receptacle opening.

In some embodiments of the breathing mask, the wall thickness in the region of the side regions is greater than the wall thickness of the sealing lip. However, it is also possible that the sealing lip has the same wall thickness as the side regions of the mask bead.

In some embodiments of the breathing mask, the wall thickness of the mask bead decreases continuously from the side regions to the sealing lip. Within the sealing lip, the wall thickness can decrease further, for example to reach the lowest wall thickness at the edge of the sealing lip. On the other hand, however, it can also be possible that the wall thickness increases again within the sealing lip.

In some embodiments of the breathing mask, the wall thickness of the mask bead is less in the nasal bridge region and base region than in the side regions, wherein the wall thickness increases in the base region toward the side regions, so that a transition region results, which is arranged at least partially in the base region, wherein the wall thickness in the nasal bridge region and the base region at least corresponds to the wall thickness of the sealing lip. This is also to be understood to mean that the wall thickness can decrease from the base region or the nasal bridge region to the sealing lip. Thus, for example, the side regions could have the greatest wall thickness, the nasal bridge region and the base region could have a lesser wall thickness in relation thereto, wherein the sealing lip has the lowest wall thickness. For example, it is also possible that the wall thickness of the sealing lip is greater or less in the regions starting from the side regions than in the regions starting from the nasal bridge region or the base region.

In some embodiments of the breathing mask, the contact region of the mask bead has corner points at the transitions from the nasal bridge region to the side region and from the base region to the side region, which are used for the alignment of the breathing mask on the face. For this purpose, these corner points have, for example, a higher wall thickness at least at points, which can partially also be greater than the wall thickness of the side regions. These corner points can also be formed, for example, as regions at the transitions between side region and nasal bridge region or base region.

In some embodiments of the breathing mask, the sealing lip protrudes starting from the side regions, the nasal bridge region, and the base region in an arc into the receptacle opening of the mask bead.

In some embodiments of the breathing mask, the filter receptacle is formed as a surface, thus has a significantly greater extension in a direction x2 and a direction y2 perpendicular thereto than in a direction z2 perpendicular to the plane E2 spanned by x2 and y2. For example, the ratio between extension in the direction z2 and the extension in the direction y2 or x2 is at least 1:10.

In some embodiments of the breathing mask, the ratio of the area of the receptacle opening of the breathing mask to the area of the filter device through which flow occurs is between 2:1 and 1:2, wherein the area of the filter device through which respiratory gas flows is at least 16 cm². If more than one filter device is provided, the area of the filter device through which flow occurs thus relates to the entire area through which flow occurs, thus the sum of the areas through which flow occurs of all provided filter devices. If, for example, two filter devices having equal area through which flow occurs are provided, the area through which flow occurs of a filter device is to be at least 8 cm², so that in total at least 16 cm² of area through which flow occurs are provided.

In some embodiments of the breathing mask, the respiratory gas chamber and the filter device are at least dimensioned so that it is possible to wash out CO2. The respiratory gas chamber is dimensioned, for example, so that it has a volume of 180 ml to 500 ml.

In some embodiments of the breathing mask, the filter device is arranged so that a substantially unobstructed flow is enabled between mouth/nose and filter device. The respiratory gas flow should thus have the most direct possible path between mouth/nose and filter device or through the filter device.

In some embodiments of the breathing mask, the filter receptacle defines a plane E2 and the mask bead defines a plane E1, wherein the mask bead is constructed essentially mirror-symmetrically. The mirror plane E3 extends here through the base region and the nasal bridge region, but not through the side regions. The plane E1 intersects the mirror plane E3 and is spanned by at least two connecting lines (L1, L2), wherein the connecting lines (L1, L2) each extend between a point (p1, p2) on the outside of the contact region facing toward the face of the user and the associated mirror point (p1′, p2′).

In some embodiments of the breathing mask, the planes E1 and E2 extend in parallel to one another and are spaced apart from one another.

In some embodiments of the breathing mask, the planes E1 and E2 extend perpendicularly to the mirror plane E3.

In some embodiments of the breathing mask, the plane E1 is perpendicular to the mirror plane E3 and the plane E2 extends inclined at an angle of 0° to 15° in relation to the plane E1 and/or the mirror plane E3.

In some embodiments of the breathing mask, the planes E1 and E2 are perpendicular or inclined at an angle between 90° and 45° in relation to one another.

In some embodiments of the breathing mask, the filter material is conFig.d and formed to filter germs (e.g., viruses, bacteria, fungi) and other microorganisms out of the air and/or other gases and retain them on and/or in the filter material. Moreover, it is possible, for example, that the filter material consists of a material which can be easily reprocessed after use, without then having restrictions in the functionality.

In some embodiments of the breathing mask, the filter material essentially consists of plastic fibers.

In some embodiments of the breathing mask, the filter material essentially consists of polypropylene.

In some embodiments of the breathing mask, the filter receptacle encloses the outer edges of the filter element in a respiratory-gas-tight manner.

In some embodiments of the breathing mask, the filter receptacle accommodates the filter element in such a way that a respiratory gas flow through the filter device is possible exclusively through the filter material (401) contained in the filter element.

In some embodiments of the breathing mask, the filter element comprises at least one filter frame, wherein the filter material is clamped or pinched in the filter frame or is connected to the filter frame.

In some embodiments of the breathing mask, at least one locking device is arranged on the filter frame, wherein the locking device is formed as a locking projection and/or as a locking recess. This locking device can be used, for example, to lock the filter element in the filter receptacle, thus, on the one hand, to align it, but also, for example, to secure the filter element against slipping or falling out of the filter receptacle.

In some embodiments of the breathing mask, the filter receptacle comprises a filter receptacle base and optionally a filter holder.

In some embodiments of the breathing mask, the filter receptacle base and the filter holder have a screw thread by which the filter receptacle base and the filter holder are connected to one another.

In some embodiments of the breathing mask, the filter receptacle is connected in a respiratory-gas-tight manner to the mask body or is part of the mask body. A respiratory-gas-tight connection between mask body and filter receptacle can be produced, for example, in that the mask body is manufactured from an elastomeric material and has an undercut or a recess into which the filter receptacle or at least the filter receptacle base can be pressed. The recess would have to completely enclose and abut the edges of the filter receptacle for this purpose, so that a respiratory-gas-tight connection results. Alternatively, it is also possible to adhesively bond the filter receptacle or at least the filter receptacle base in the mask body.

In some embodiments of the breathing mask, the mask body is manufactured integrally with the mask bead and the strap holder.

In some embodiments of the breathing mask, the filter receptacle is connected to the mask body by extrusion coating. In some embodiments of the breathing mask, the filter receptacle is also manufactured integrally with the mask body, the mask bead, and the strap holder.

In some embodiments of the breathing mask, the strap holder is formed and conFig.d to accommodate at least one head fastening strap.

In some embodiments of the breathing mask, the strap holder is formed as a fastening projection protruding from the mask body, wherein feedthrough openings for feeding through the head fastening strap are arranged in the fastening projection.

In some embodiments of the breathing mask, the feedthrough openings taper at least partially in a funnel shape or conically.

In some embodiments of the breathing mask, the head fastening strap is manufactured integrally with the strap holder and is optionally formed as a loop.

In some embodiments of the breathing mask, the mask body, the strap holder, and/or the filter receptacle is produced from a dimensionally stable plastic.

In some embodiments of the breathing mask, the mask body, the strap holder, and/or the filter receptacle is produced from an elastomeric plastic.

In some embodiments of the breathing mask, the mask body, the strap holder, and/or the filter receptacle is produced from a polycarbonate, a polyamide, a polypropylene, a polyoxymethylene, or a silicone. It is not necessarily required here for the individual components to be produced from the same materials. For example, the mask body together with the strap holder can be produced from a silicone and the filter receptacle can be produced from another material.

In some embodiments of the breathing mask, the mask bead is produced from silicone.

In some embodiments of the breathing mask, the strap holder is produced from the same material as the mask body.

In some embodiments of the breathing mask, the filter receptacle is produced from the same material as the mask body.

In some embodiments of the breathing mask, the filter receptacle is produced from a dimensionally stable plastic and the mask body is produced from an elastomeric plastic.

In some embodiments of the breathing mask, the head fastening strap is an elastic strap.

In some embodiments of the breathing mask, the mask body is produced integrally with the mask bead, the strap holder, and the filter receptacle.

In some embodiments of the breathing mask, the breathing mask is constructed and produced from one or more materials in such a way that the breathing mask, optionally without filter element, can be cleaned in a germicidal manner. The breathing mask is to remain as undamaged as possible in this case, that is to say at least is not to suffer any damage influencing the functionality, for example due to partial degradation/dissolving of the breathing mask. Methods for germicidal cleaning are, for example, autoclaving, washing, dry heating, or spraying on a disinfectant.

In some embodiments of the breathing mask, the filter receptacle and the filter element are configured and adapted to one another in such a way that it is possible to change the filter element while wearing the breathing mask, wherein exclusively the filter element has to be touched by the extremities of the user or another person. For example, only the filter element comes into contact with a hand of the user or another person. The breathing mask itself would nonetheless continue to rest respiratory-gas-tight on the face of the user in this case due to the head fastening strap and the strap holder.

In some embodiments, the filter element can be removed from the filter receptacle and/or inserted into the filter receptacle with a hand movement. Such a hand movement can be, for example, pulling on a handle on the filter element or a screwing movement.

In some embodiments of the breathing mask, at least one pressing edge is formed on the filter receptacle base, onto which the filter material is pressed by the filter holder.

In some embodiments of the breathing mask, at least one holding tip is formed or arranged on the filter receptacle webs of the filter receptacle base.

In some embodiments of the breathing mask, at least one mounting projection is formed on the filter receptacle base and a recess is formed in the mask body to accommodate this mounting projection.

In some embodiments of the breathing mask, at least one pressing edge is formed on the filter holder, which presses on the filter material and/or at least partially fixes and/or clamps it on the filter receptacle base.

In some embodiments of the breathing mask, at least one mounting projection is formed on the filter holder and at least one groove is formed in the mask body to accommodate the at least one mounting projection.

In some embodiments of the breathing mask, the locking device at least partially consists of a tab on the filter holder, wherein the tab, together with the filter holder edge, forms at least one locking recess for accommodating at least one locking projection.

In some embodiments of the breathing mask, at least one mounting opening is arranged in the mask body, which is designed for feeding through and holding the at least one locking projection of the filter receptacle base.

The invention is described hereinafter in the form of exemplary embodiments of the invention on the basis of illustrations, some of which are greatly simplified.

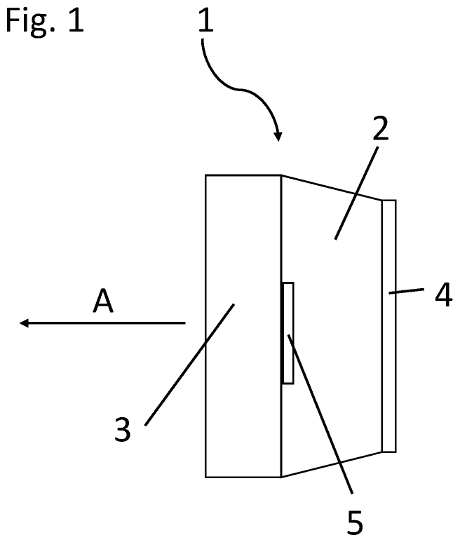

FIG. 1 schematic illustration of a breathing mask in a side view.

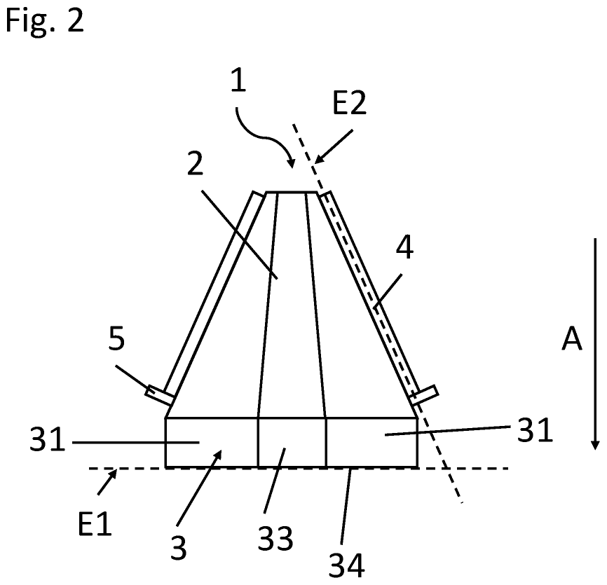

FIG. 2 schematic illustration of a breathing mask having two filter devices in a top view.

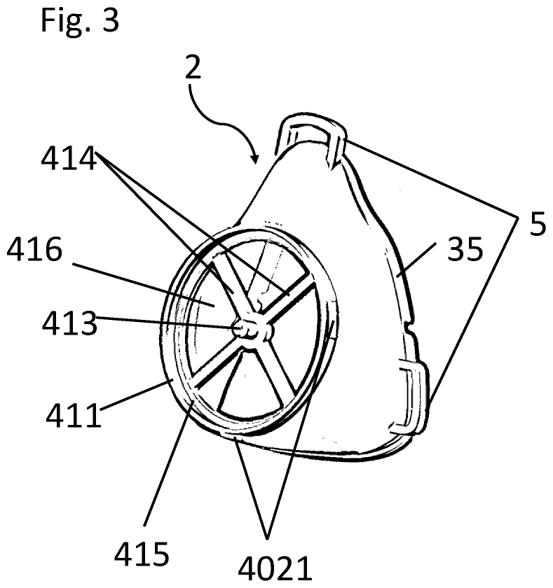

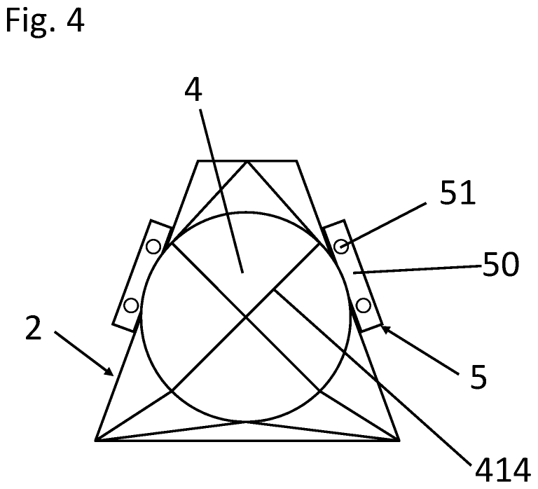

FIG. 3 perspective illustration of a mask body with filter receptacle.

FIG. 4 schematic illustration of a mask body with filter receptacle in a front view.

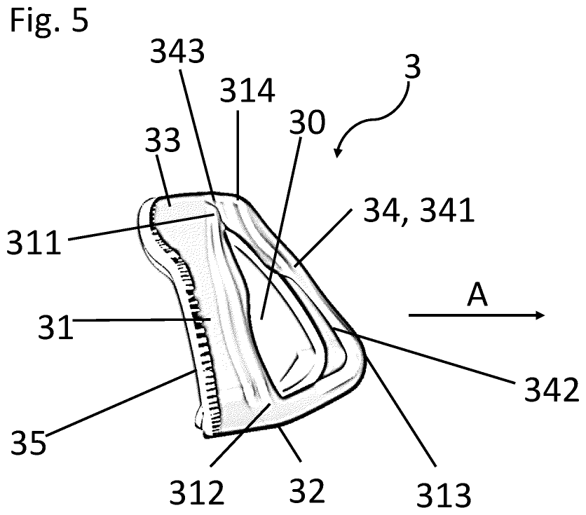

FIG. 5 perspective illustration of a mask bead.

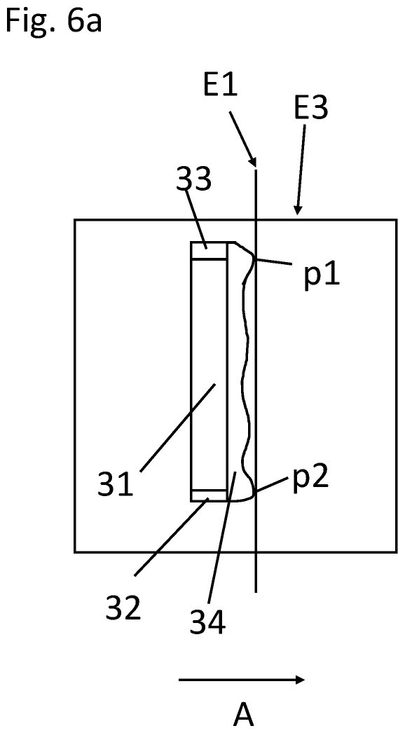

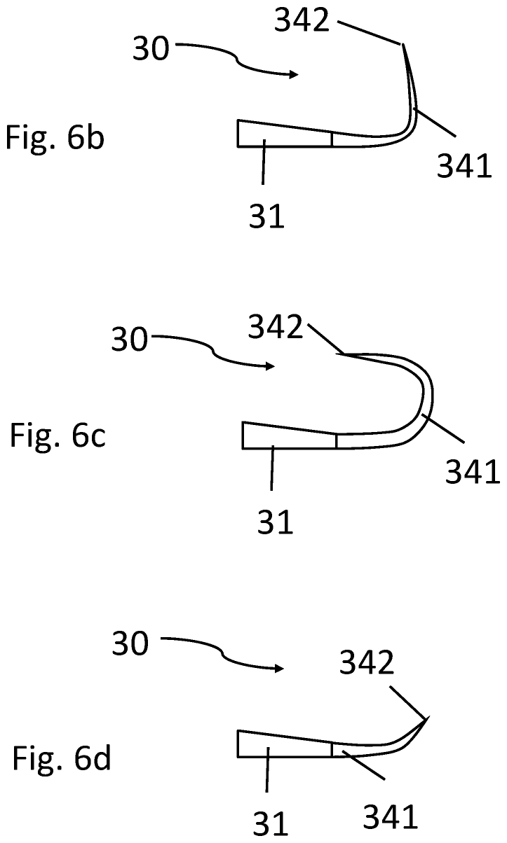

FIG. 6a schematic side view of a mask bead.

FIG. 6b schematic illustration of the course of a sealing lip.

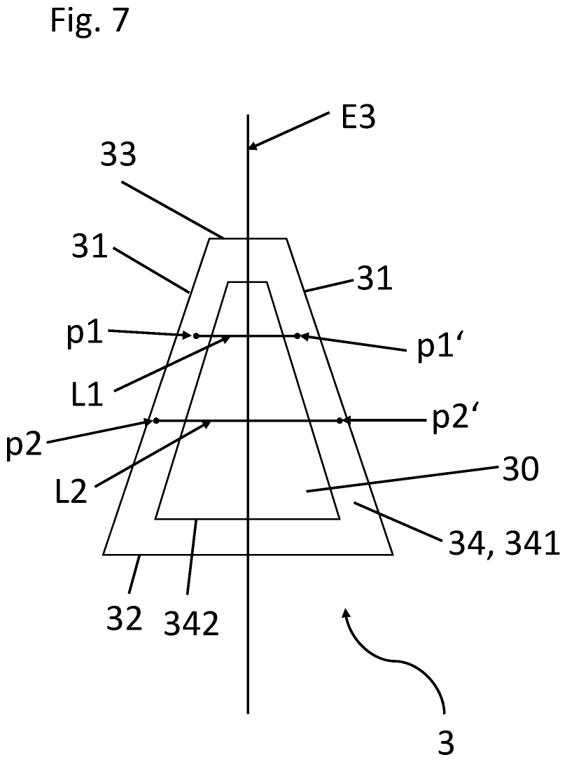

FIG. 7 schematic illustration of a mask bead in a front view.

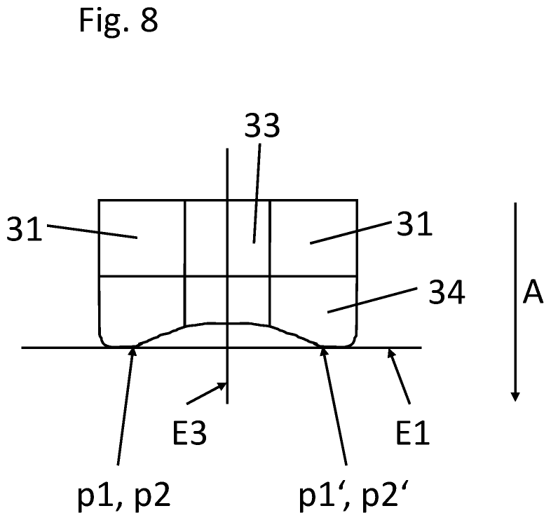

FIG. 8a schematic illustration of a mask bead in a top view.

FIG. 8b schematic illustration of a mask bead in a side view.

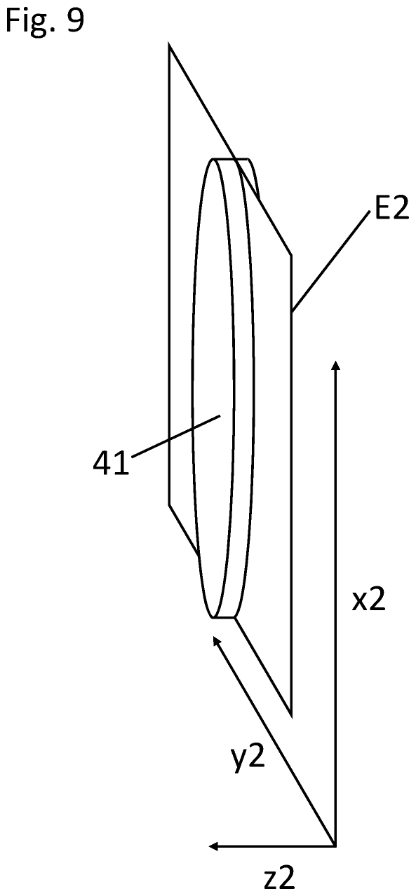

FIG. 9 schematic illustration of a filter receptacle in a perspective view.

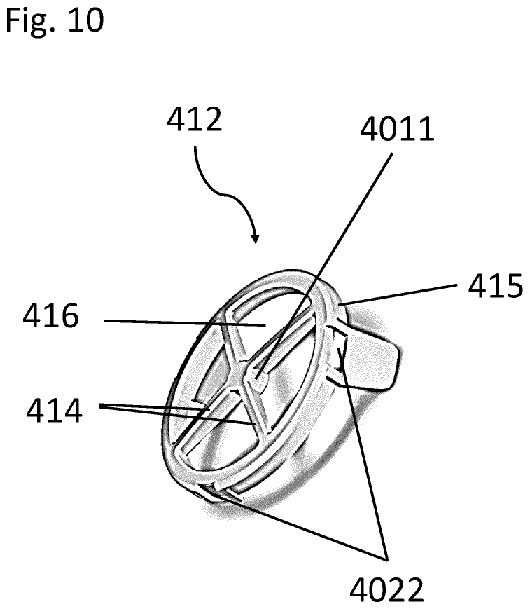

FIG. 10 perspective illustration of a filter holder.

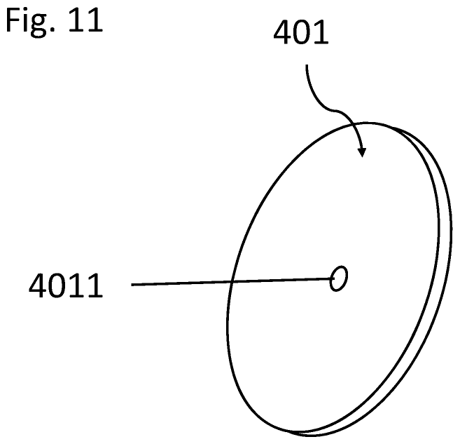

FIG. 11 perspective illustration of a filter element.

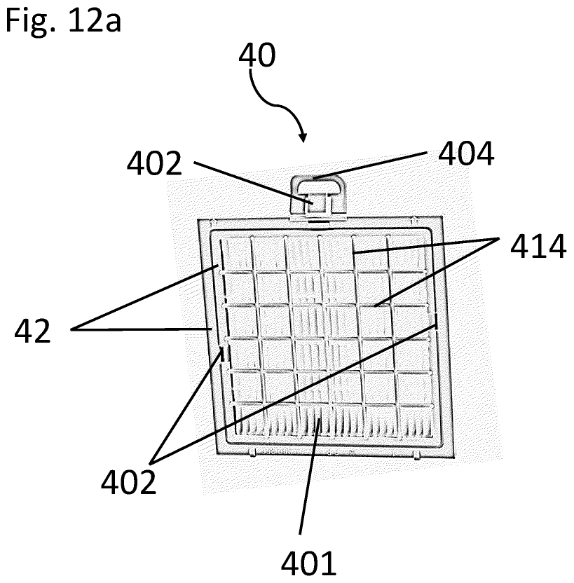

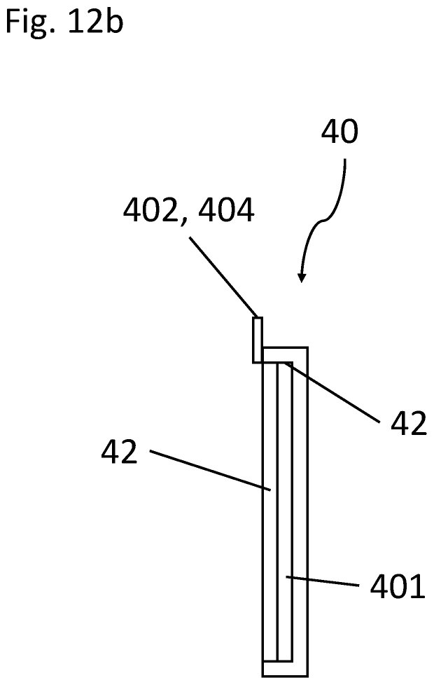

FIG. 12a schematic front view of a filter element.

FIG. 12b schematic cross section through a filter element.

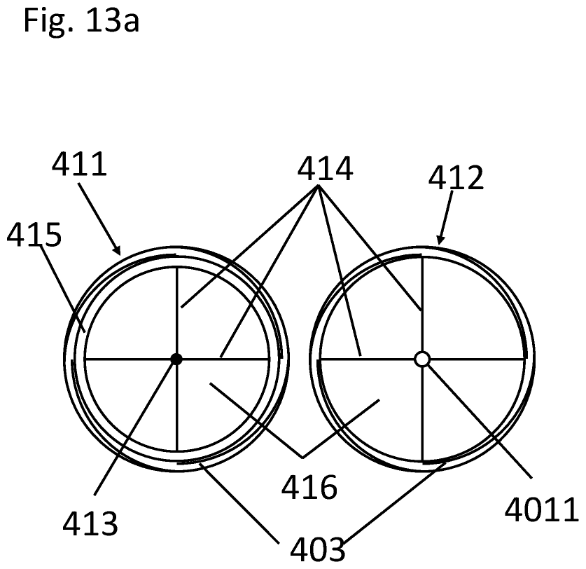

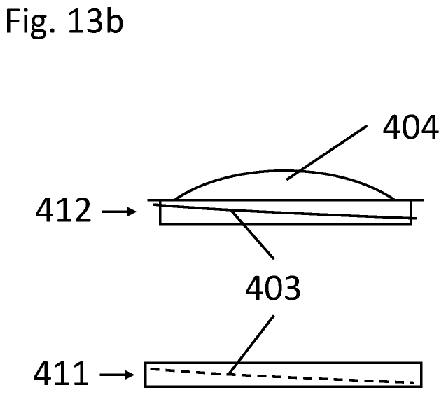

FIG. 13a schematic illustration of a filter receptacle base and a filter holder.

FIG. 13b schematic illustration of a filter receptacle base and a filter holder.

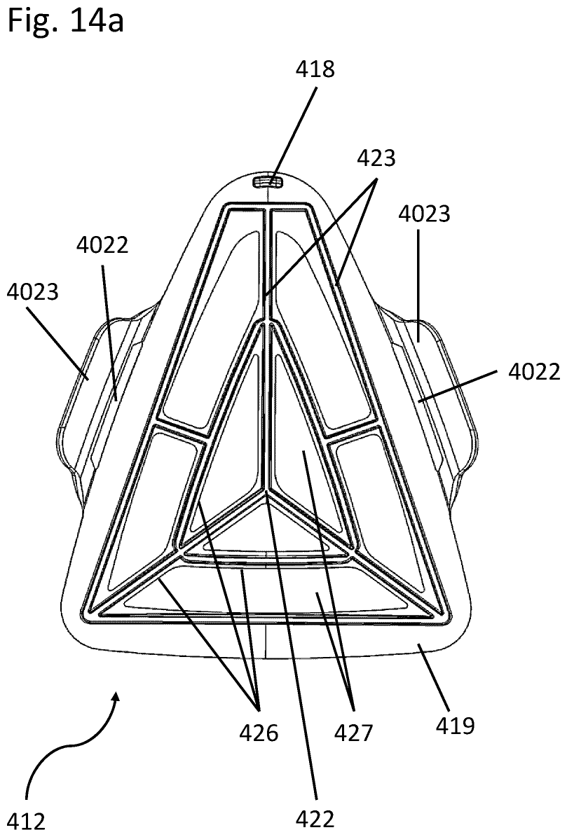

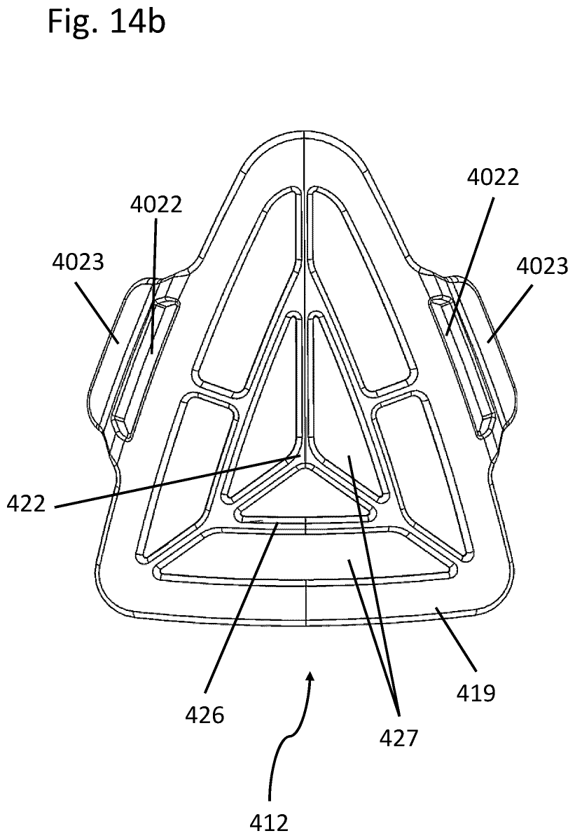

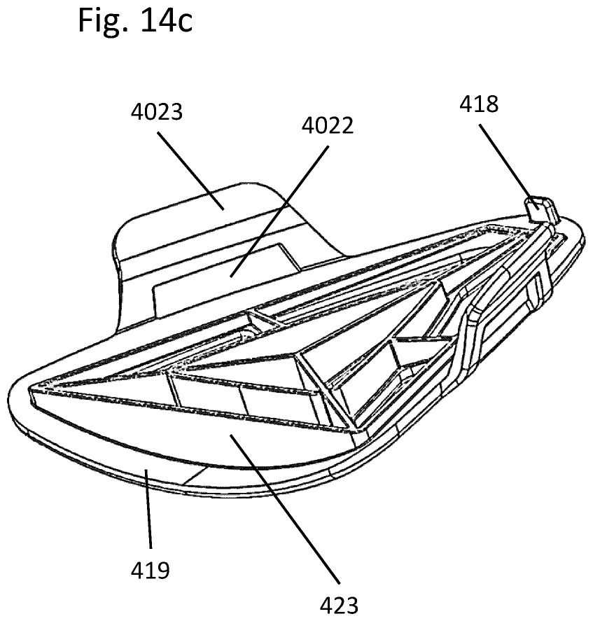

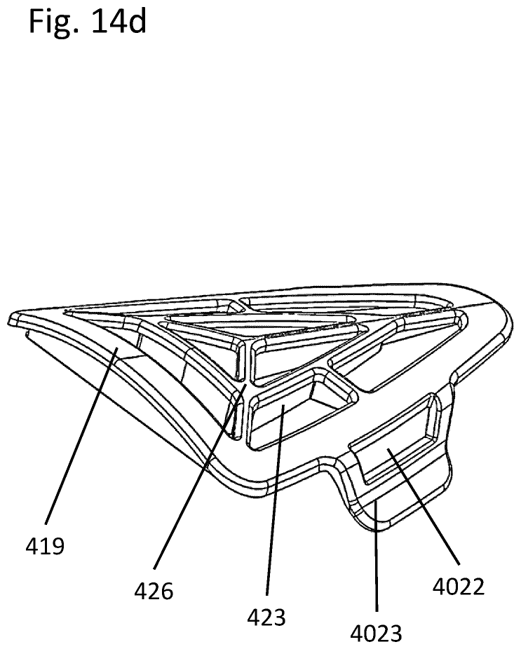

FIG. 14a schematic illustration of a filter holder.

FIG. 14b schematic illustration of a filter holder.

FIG. 14c perspective illustration of a filter holder.

FIG. 14d perspective illustration of a filter holder.

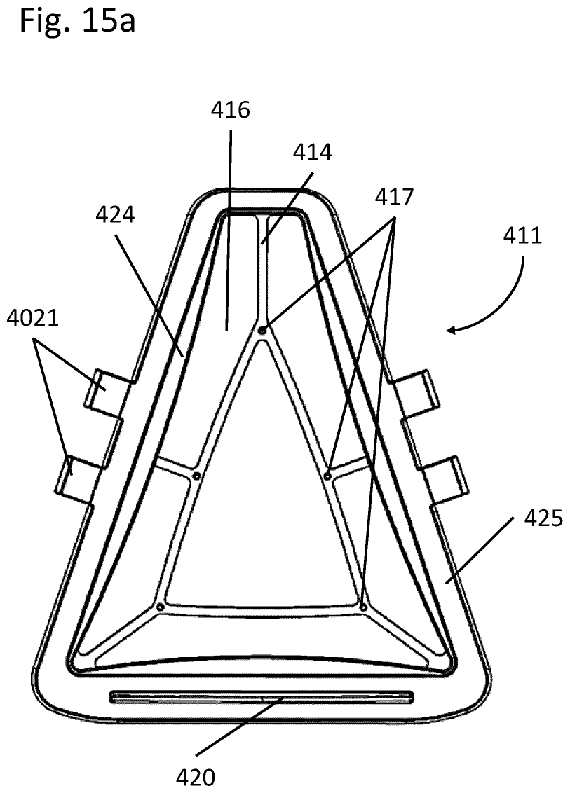

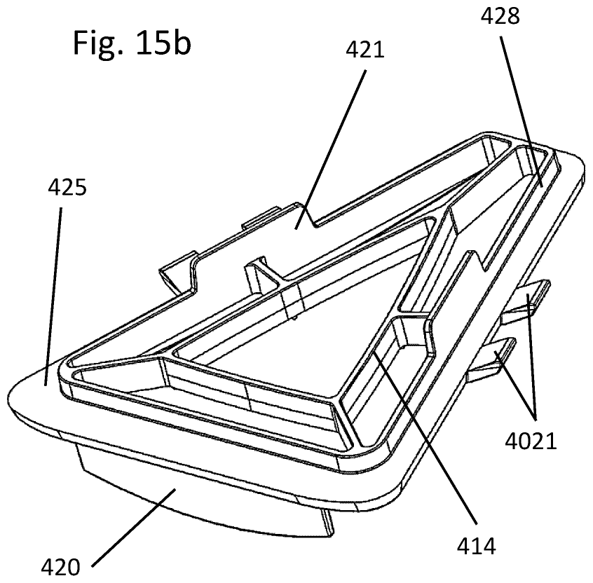

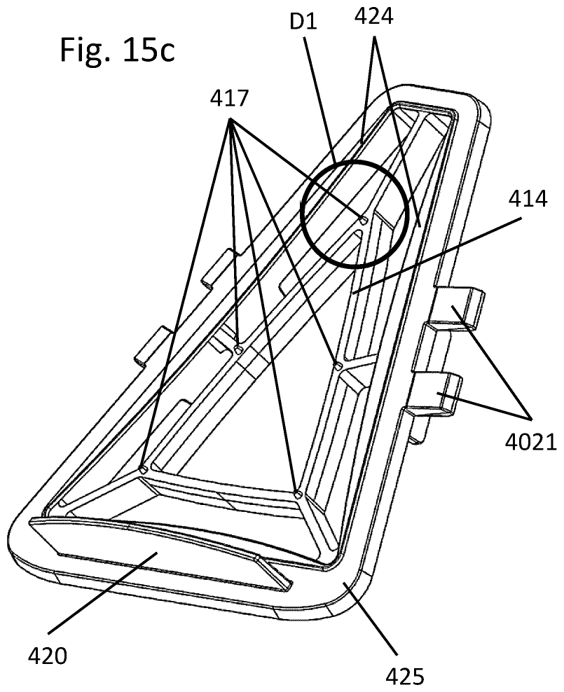

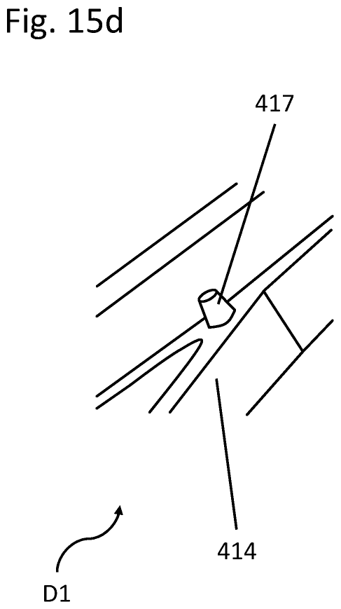

FIG. 15a schematic illustration of a filter receptacle base.

FIG. 15b schematic illustration of a filter receptacle base.

FIG. 15c schematic illustration of a filter receptacle base.

FIG. 15d detail D1 from FIG. 15c.

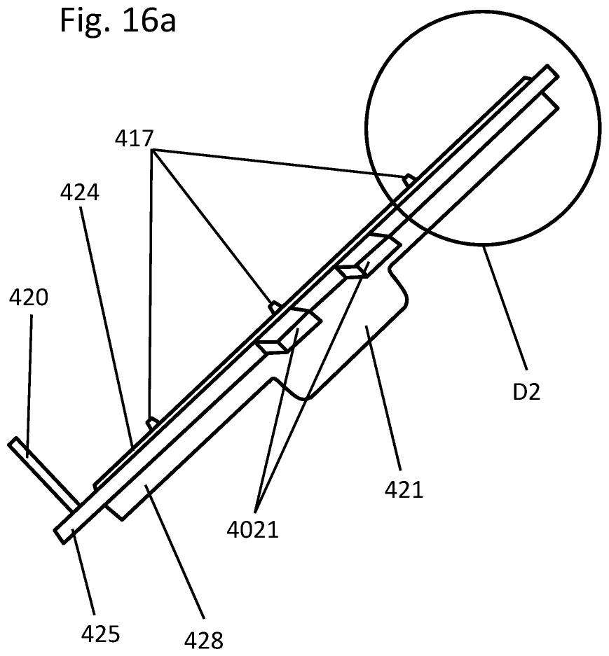

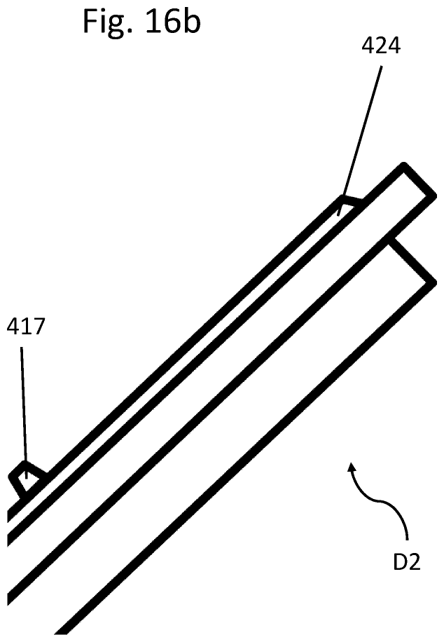

FIG. 16a side view of a filter receptacle base.

FIG. 16b detail D2 from FIG. 16a.

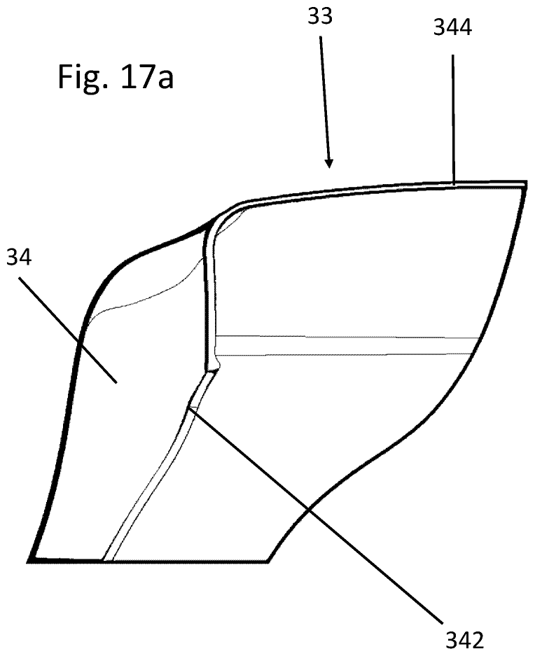

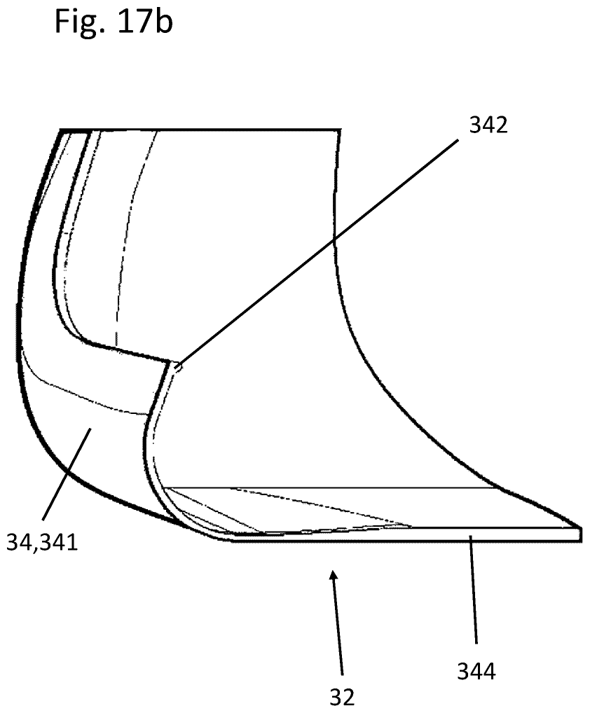

FIG. 17a detail/cross section from the mask bead.

FIG. 17b detail/cross section from the mask bead.

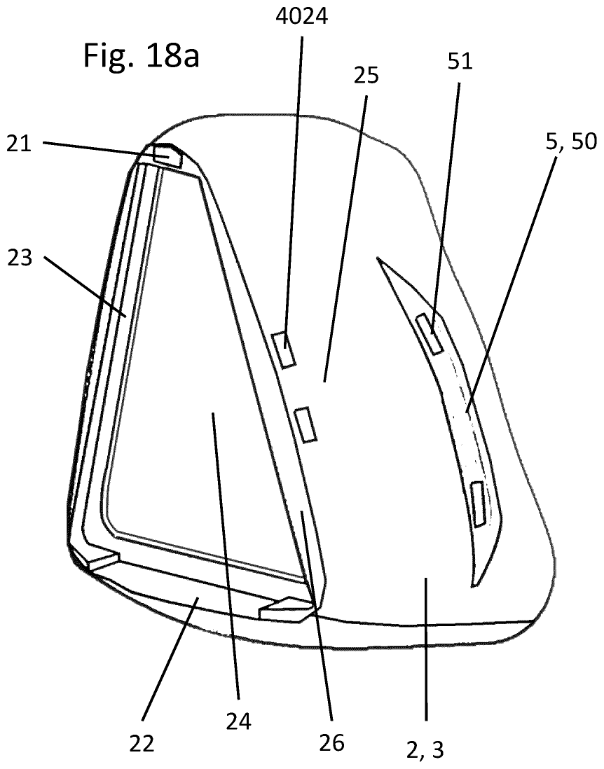

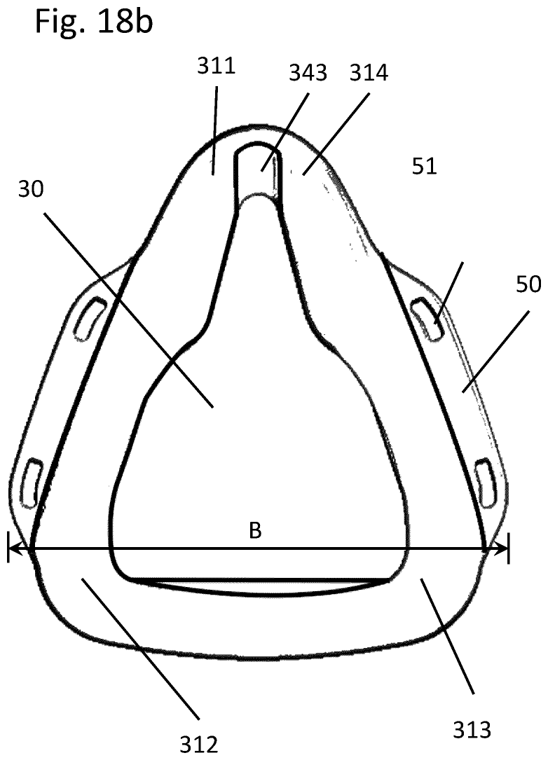

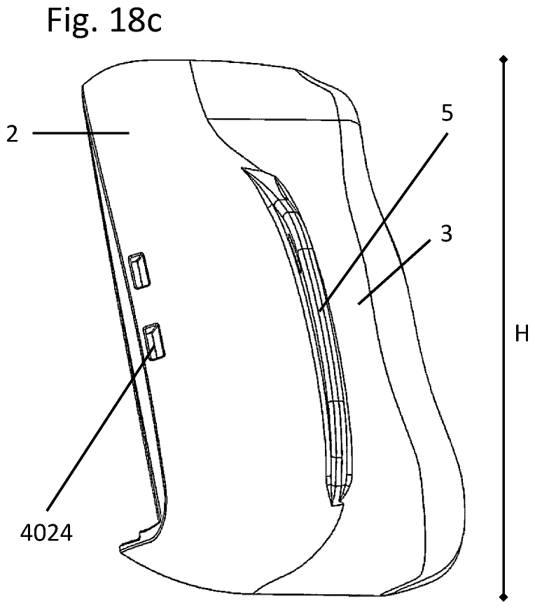

FIG. 18a one-piece mask body with mask bead in perspective.

FIG. 18b one-piece mask body with mask bead in a front view.

FIG. 18c one-piece mask body with mask bead in a side view.

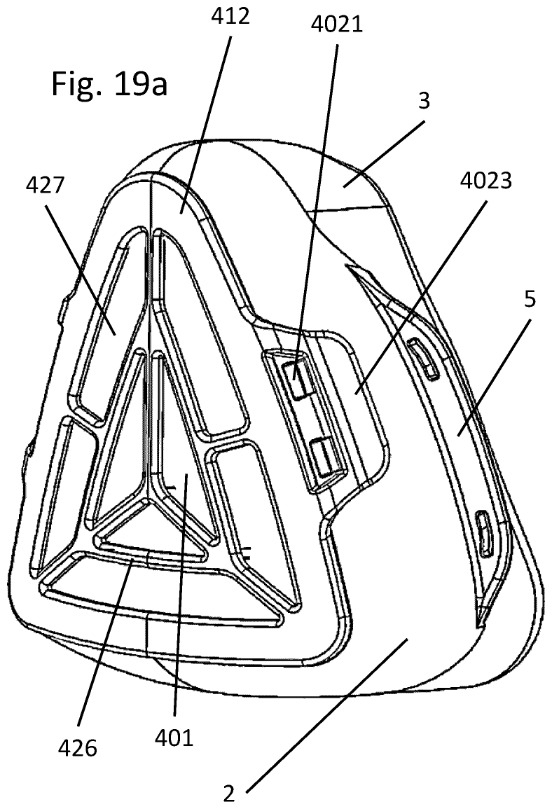

FIG. 19a perspective view of a breathing mask.

FIG. 19b detail view of locking.

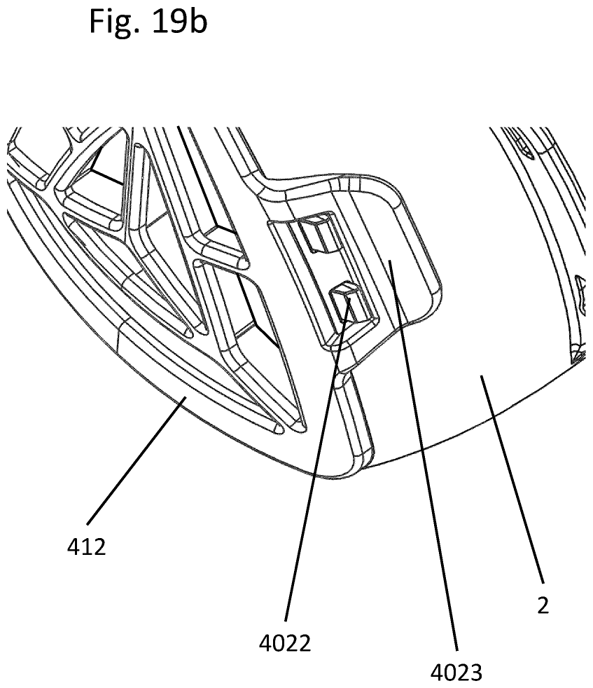

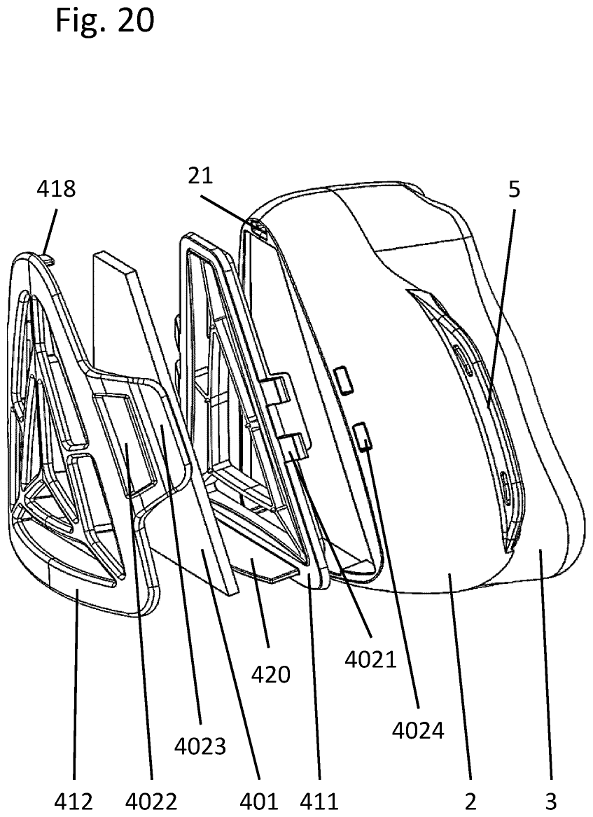

FIG. 20 exploded view breathing mask.

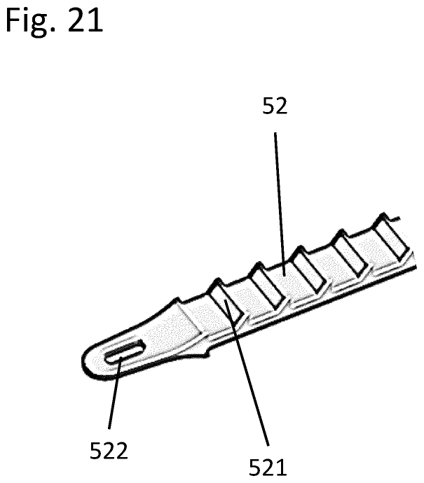

FIG. 21 detail strap.

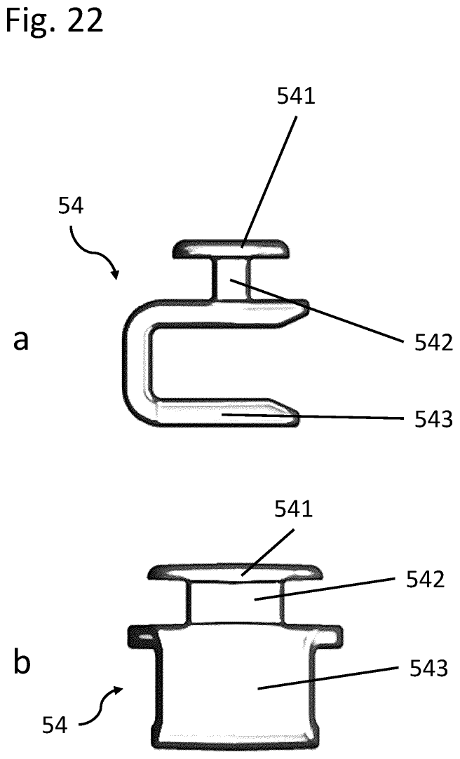

FIG. 22a holding clip for a strap.

FIG. 22b holding clip for a strap.

FIG. 1 shows a greatly simplified, schematic illustration of an exemplary embodiment of the breathing mask 1 in a side view. The breathing mask 1 comprises here a mask body 2, a mask bead 3, a filter device 4, and a strap holder 5. The general direction toward the user is indicated by the arrow identified by A, the mask bead 3 thus faces here in the direction toward the user. The mask bead 3, the filter device 4, and the strap holder 5 are connected to the mask body. In one exemplary embodiment, the mask body 2 is produced integrally together with the strap holder 5, while the mask bead 3 and the filter device 4 are produced separately and are connected later to the mask body. The mask bead 3 can be plugged onto the mask body 2, for example, via the mask fitting 35 (not shown in greater detail in FIG. 1), which results in a reversible bond between mask body 2 and mask bead 3. A permanent connection by, for example, adhesive bonding, extrusion coating, or other connection methods is also possible.

The strap holder 5 can be, for example, a fastening projection 50, which is provided with at least one feedthrough opening 51, through which a head fastening strap 52 (not shown) can be guided and is, for example, knotted behind it, so that a solid seat of the breathing mask 1 on the face of the user is ensured. If the feedthrough opening 51 is made conical or funnel-shaped, for example, wherein the feedthrough opening 51 is arranged tapering in the direction away from the user, but not closing, knotting of the head fastening strap 52 is possibly not necessary since, although easy threading is enabled by the funnel shape, on the other hand the opposite pulling direction is blocked or at least made much more difficult. Alternatively, the strap holder 5 is designed, for example, as a type of lashing eye, through which the head fastening strap 52 can be guided. For example, the head fastening strap 52 is equipped for this purpose with a hook-and-loop closure, so that a length adjustment is possible. In other and further exemplary embodiments, the head fastening strap 52 is an elastic strap, which is guided in a stretched state over or behind the head of the user and then in a less stretched state presses the breathing mask 1 lightly against the face of the user in order to seal it in a respiratory-gas-tight manner with respect to the face.

FIG. 2 shows a simplified schematic illustration of an exemplary embodiment of a breathing mask 1 according to the invention in a top view, wherein two filter devices 4 are arranged on the breathing mask. The planes E1 and E2 are indicated as examples in FIG. 2, wherein the plane E2 extends through the filter device and the plane E1 extends along the contact region 34 of the mask bead 3. The filter devices 4 are arranged so that the plane E2 extending through the filter device 4 extends at an angle between 45° and 90° in relation to the plane E1 extending on the contact region 34 and intersects it.

FIG. 3 shows an exemplary embodiment of a mask body 2 of the breathing mask 1 in a perspective view. The filter receptacle 41 or the filter receptacle base 411 is produced integrally with the mask body 2. The filter receptacle base 411 is, for example, round and has a filter receptacle lug 413 in the center, on which a filter element 40 can be aligned and which is connected via webs 414 to the filter receptacle edge 415 of the filter receptacle base 411. A filter receptacle opening 416 is defined by the filter receptacle edge 415, through which filter receptacle opening 416 the respiratory gas can flow out of the respiratory gas chamber into or through the filter element 40 and can flow from the filter element 40 into the respiratory gas chamber. For example, the filter element 40 can be laid on the filter receptacle base 411 and then solidly clamped using a filter holder 412 (not shown in FIG. 3) in the filter receptacle 41. The webs 414 and the filter receptacle edge 415 are designed for this purpose in such a way that the filter element 40 can rest thereon and cannot be pressed—at least inadvertently—through the filter receptacle base 411 into the respiratory gas chamber of the breathing mask 1. The filter element 40 is to be embodied here, for example, in such a way that the diameter of the filter element 40 corresponds to the internal diameter of the filter receptacle base 411. For easy positioning inside the filter receptacle 41, for example, a positioning hole 4011 corresponding to the filter receptacle lug 413 is arranged in the filter element 40. Moreover, locking projections 4021 are attached by way of example to the filter receptacle base 411. The filter holder 412 can be locked on these locking projections 4021, for example. For this purpose, the filter holder 412 would have corresponding locking recesses 4022. In a further exemplary embodiment of the breathing mask 1, the filter receptacle base 411 has a screw thread 403, so that the filter element 40 or the filter holder 412 can be screwed together with the filter receptacle base 411. The round shape of the filter receptacle base 411 is to be viewed as an example, i.e., the shape can also be embodied as a rectangle or polygon or as free form. In this case, the filter holder 412 and the filter element 40 would also have to be adapted in their shape to the filter receptacle base 411, so that a respiratory-gas-tight seat can be achieved.

Strap holders 5 are attached in the upper region of the exemplary mask body 2 and in the side region of the mask body 2. The strap holders 5 are embodied, for example, as a type of lashing eye, through which the head fastening strap 52 can be guided. An exemplary embodiment of a head fastening strap 52 has, for example, a hook-and-loop closure, thus regions which are provided with small barbs and regions which are provided with, for example, a fleece. Such an exemplary head fastening strap 52 can represent a simple option for adjusting the length of the head fastening strap 52 to the head shape of the user in order to achieve a comfortable and secure seat of the breathing mask 1.

Furthermore, a mask fitting 35 is shown in FIG. 3, which enables, for example, a reversible connection to a mask bead 3. A mask bead 3 can be plugged onto the mask fitting 35, for example. A permanent connection of the mask bead 3 to the mask body 2 by, for example, adhesive bonding or extrusion coating would also be possible at this point.

The exemplary embodiment of the mask body 2 shown in FIG. 3 is manufactured, for example, from a dimensionally stable plastic. Manufacturing from an elastomeric material is also possible.

In particular if the mask body 2 is manufactured from a dimensionally stable plastic, the mask bead 3 is manufactured separately and connected later to the mask body 2.

In a further exemplary embodiment of the breathing mask 1, the mask body 2 is integrally produced together with the filter receptacle base 411 from an elastomeric material. The filter receptacle base 411 can be embodied here in such a way that it is at most as large, for example, is slightly smaller than the filter element 40 and is provided without locking device. The filter element 40 can then be pressed into the filter receptacle base 411 and pulled out again for a change. For this purpose, it is advantageous if the filter element 40 also has, in addition to the filter material 401, a filter frame 42, which again has sufficient stability so that the filter element 40 can be inserted securely into the filter receptacle base 411.

FIG. 4 shows a greatly simplified illustration of an exemplary embodiment of the breathing mask 1 having a filter device 4 in a front view. The filter device 4 is arranged here as in the exemplary embodiment in FIG. 3. In contrast to FIG. 3, the strap holder 5 is embodied, for example, as a fastening projection 50 having two feedthrough openings 51 for in each case at least one head fastening strap 52. An elastic strap can be guided as a head fastening strap 52 through the feedthrough openings 51, for example, which is guided behind the head of the user to achieve a solid seat of the breathing mask 1 on the face, at least in the region around the nose and the mouth. To prevent loosening of the seat or slipping of the head fastening strap 52 out of the strap holder 5, the ends of the head fastening strap 52 are knotted, for example, on the side of the strap holder 5 facing away from the user. In the schematically shown exemplary embodiment of the strap holder 5 having two feedthrough openings 51 in each case, for example, a total of two head fastening straps 52 are threaded through the strap holder 5. For example, the one head fastening strap 52 is guided between the respective upper feedthrough openings 51 and the second head fastening strap 52 is guided through the respective lower feedthrough openings 51.

For example, the feedthrough openings 51 are tapering conically or in a funnel shape opposite to the direction toward the user. With feedthrough openings 51 shaped in such a way, knotting of the ends of the head fastening strap 52 can possibly be omitted, since the funnel-shaped feedthrough openings 51 permit easy feeding through of the strap in the direction in which the feedthrough openings 51 taper. Against the tapering direction of the feedthrough opening 51, in contrast, the movement of a strap is blocked or at least strongly obstructed. For this purpose, it is advantageous if the head fastening strap 52 used has, for example, a somewhat larger cross section, independently of the shape, than the smallest cross section of the feedthrough opening 51.

FIG. 5 shows a perspective illustration of an exemplary mask bead 3 for a breathing mask 1 according to the invention. The mask bead 3 delimits the receptacle opening 20 to the sides by way of two side regions 31, a base region 32, and a nasal bridge region 33. The area of the receptacle opening 30 is determined in the direction A toward the user by the edge 342 of the contact region 34 embodied as a sealing lip 341. The contact region 34 simultaneously represents the front boundary, i.e., the side facing toward the user, of the receptacle opening 30 by the mask bead 3. The mask fitting 35 forms the transition to the mask body 2 in the “rear”, i.e., the side of the mask bead 3 facing away from the user. The receptacle opening 30 is designed for this purpose to enclose at least the nose and mouth of the user, wherein the mask bead 3 presses via the sealing lip 341 in a respiratory-gas-tight manner against the face of the user and forms a seal. In the mask bead shown as an example in FIG. 5, the corner points 311, 312, 313, and 314 are additionally formed, which are solidified in relation to the remaining mask bead or have an increased wall thickness, for example. These corner points are arranged, for example, in such a way that they rest on less sensitive points in the face of the user and thus additionally support the mask bead and are additionally also used for the alignment of the breathing mask 1. The supporting function of these corner points also enables, for example, other regions of the mask bead 3 to be embodied having a lesser wall thickness. The mask bead 3 can thus have a significantly lower wall thickness in the nasal bridge region 33, for example, which has the result that in this region the mask bead is not supported with respect to the face and is configured to be more flexible. The mask bead 3 or the sealing lip 341 can thus more easily adapt itself in this region to the facial contour and at the same time does not exert additional pressure in the sensitive region of the nasal bridge of the user. In addition to the lesser wall thickness, a notch 343 is also arranged in the nasal bridge region 33 in the exemplary mask bead 3, which additionally enables easier adaptation to the facial contours of the user.

The mask bead 3 is manufactured, for example, from an elastomeric material either integrally with the mask body 2 (and optionally the filter receptacle 41 and/or the strap holder 5) or is provided separately and is connected to the mask body 2 for use. In the case of integral production with at least the mask body 2, the mask fitting 35 of the mask bead 3 merges, for example, continuously into the mask fitting 35 of the mask body 2. Sharp positioning of the respective mask fittings would thus possibly no longer be able to be made out and is to be understood here as a transition region between mask bead 3 and mask body 2. In the case of separate manufacturing of the mask bead 3, for example, if the mask body 2 is provided from a dimensionally stable plastic, the mask fitting 35 of the mask bead is configured and designed, for example, so that it can be plugged in a respiratory-gas-tight manner onto the mask body. Alternatively, a permanent connection between mask bead 3 and mask body 2 would also be possible if the two are manufactured separately. This connection can be carried out, for example, by extrusion coating, adhesive bonding, or welding or another permanent connection technology.

The shape shown of the mask bead 3 is to be understood as an exemplary embodiment of a mask bead 3 for the breathing mask 1 according to the invention. In particular in the region of the contour of the sealing lip 341 or the contact region 34, the mask bead can vary. Variations in the region of the mask fitting 35 are also comprised by the invention, wherein the contour and embodiment of the mask fitting 35 is advantageously embodied as matching with the mask body 3 or the mask fitting 35 therein.

A further, greatly simplified sketch of an exemplary embodiment of the mask bead 3 is shown in FIG. 6a in a side view. The mirror plane E3 shown extends in the mask bead 3 through the base region 32 and the nasal bridge region 33 without intersecting the side region 31. The two points p1 and p2 are marked as examples on the outer side of the contact region 34, thus the side facing toward the user. The plane E1 rests on the points p1, p2. The plane E1 is defined by connecting lines L1, L2 extending in parallel, which extend between the points p1, p2 and their mirror points p1′, p2′, as is further illustrated as shown in FIGS. 7 and 8. The points p1, p2 can be selected arbitrarily here on the outer side of the contact region 34 facing toward the user. For example, the points p1, p2 are selected so that they lie on the outermost points on the side of the mask bead 3 facing toward the user, as schematically indicated in FIG. 6a.

The contact region 34 of the mask bead 3 is embodied, for example, as a sealing lip 341. The sealing lip 341 protrudes, for example, starting from the side region 31, the base region 32, and the nasal bridge region 33 in an arc into the receptacle opening 30. Various cross sections of the sealing lip 341 are outlined by way of example and greatly simplified in FIGS. 6b, c, d. An exemplary cross section is shown in FIG. 6b, in which the wall thickness decreases continuously from the side region 31 in the direction of the sealing lip 341. In the sealing lip 341, the wall thickness decreases further in the direction of the edge 342. The cross section of the sealing lip 341 describes an arc here, so that the edge protrudes with a length into the receptacle opening 30. The part of the sealing lip 341 protruding into the receptacle opening 30 is perpendicular to the side region 31 here. The edge 342 of the sealing lip defines the area of the receptacle opening 30. The part of the sealing lip protruding essentially perpendicularly into the receptacle opening moreover also represents a surface which rests on the face of the user.

FIG. 6c shows an exemplary cross section of the side region 31 and of the sealing lip 341, wherein the sealing lip folds over in an arc starting from the side region 31 into the receptacle opening, so that the edge points within the receptacle opening in the direction opposite to the user. As also in the course described in FIG. 6b, a section of the sealing lip 341 extending perpendicularly to the side region 31 thus also results, which forms, for example, a contact surface on the face of the user. The wall thickness of the mask bead takes a similar course here as described for FIG. 6b—decreasing from the side region 31 into the sealing lip 341, wherein the wall thickness in the sealing lip 341 decreases further to the edge 342.

A further exemplary embodiment of the mask bead 3 is outlined in simplified form in FIG. 6d. The wall thickness decreases in the side region 31 toward the sealing lip 341 and decreases further within the sealing lip 341 toward the edge 342. The course of the cross section of the sealing lip 341 describes a small arc here, so that the edge 342 only protrudes slightly into the receptacle opening 30. In contrast to the exemplary embodiments described in FIG. 6b, c, a surface perpendicular to the side region 31 does not result here, at least without contact on the face of the user. Upon contact, however, it is conceivable that the sealing lip 341 or the edge 342 is pressed further into the receptacle opening 30 and the sealing lip at least partially rests flatly on the face of the user.

In the exemplary embodiments of the mask bead 3 in FIGS. 6b, c, d, the wall thickness decreases starting from the side region 31 via the sealing lip 341 to the edge 342 of the sealing lip. The wall thickness of the sealing lip 341 can also, however, remain continuous, for example, already from the transition from the side region 31. A continuous wall thickness from side region 31 to edge 342 of the sealing lip 341 is also possible. The course of the wall thickness can also vary for this purpose depending on the point in the mask bead. The wall thickness can thus be continuously uniform in the region of the corner points (311, 312, 313, 314), while the wall thickness decreases in the base region 32 toward the edge 342 of the sealing lip 341. It is also possible that initially the wall thickness of the sealing lip 341 decreases, but it increases again toward the edge 342.

FIG. 7 shows the mask bead 3 in a front view, i.e., the side facing toward the user. The mask bead 3 is constructed mirror symmetrically and the mirror plane E3 extends through the base region 32 and the nasal bridge region 33, without extending through the side regions. On the outer side, thus the side facing toward the user, of the contact region 34, the points p1, p2 can be defined, as well as the mirror points p1′ and p2′ resulting therefrom. The points p1 and p1′ or p2 and p2′ are connected by connecting lines L1, L2. These connecting lines then span a plane E1 in such a way that both connecting lines L1, L2 and thus also the points p1, p2 and their mirror points p1′, p2′ lie on the plane E1. Due to the mirror symmetrical structure of the mask bead 3, the connecting lines L1, L2 extend in parallel to one another. The planes E1 and the mirror plane E3 are perpendicular to one another.

The contact region 34 of the mask bead 3 is embodied, for example, as a sealing lip 341. The sealing lip 341 extends here, for example, in such a way that the edge 342 of the sealing lip protrudes into the receptacle opening 30. As can be seen in FIG. 7, the area of the receptacle opening 30 is defined by the edge 342 of the sealing lip. If the mask bead 3 is produced, for example, from an elastomeric or soft material, for example silicone, a change of the area of the receptacle opening 30 defined by the edge 342 can certainly result during the use of the breathing mask. The area of the receptacle opening 30 defined by the edge 342 can also vary during use depending on the facial contour of the user.

An exemplary embodiment of the mask bead 3 is outlined in FIG. 8, wherein the mask fitting 35 is not explicitly shown. The mirror plane E3 intersects the nasal bridge region 33 and the base region 32 (concealed in FIG. 8), without intersecting the side regions 31. On the outer side of the contact region 34 facing toward the user, the points p1, p2 are selected, as well as their mirror points p1′, p2′. The plane E1 rests on these points and is furthermore defined by the connecting lines L1, L2 extending in parallel between the points p1 and p1′ and p2 and p2′. The plane E1 extends perpendicular to the mirror plane E3.

FIG. 9 shows a greatly simplified perspective illustration of an exemplary embodiment of the filter receptacle 41. The filter receptacle 41 has significantly larger dimensions in the directions x2 and y2 than in the z2 direction. A plane E2 is spanned by the directions x2 and y2, which extends essentially in parallel to the surface represented by the filter receptacle 41.

In some exemplary embodiments of the breathing mask 1, the plane E2 extends essentially in parallel and at a distance to the plane E1. If the plane E2 extends in parallel to the plane E1, the plane E2 is thus also perpendicular to the mirror plane E3. The essentially parallel course of the planes E1 and E2 in relation to one another is to be understood in such a way that the plane E2 can also extend inclined at a small angle in relation to one another. In some exemplary embodiments, for example, the plane E2 extends at an angle between 0° and 15° in relation to the plane E1 and perpendicular to the mirror plane E3. Furthermore, a course of the plane E2 is also possible in which the plane E2 is at an angle between 0° and 15° to both the plane E1 and also the mirror plane E3. In some embodiments of the breathing mask 1, the filter receptacle is arranged, for example, so that the contact surface 34 of the mask bead 3 delimits the respiratory gas chamber defined by the mask body 2, the mask bead 3, and the filter device 4 on the side facing toward the user and the filter receptacle 41 delimits it on the side facing away from the user. Such a structure of the breathing mask is also described for FIGS. 1 and 3.

In further exemplary embodiments, the plane E2 extends perpendicularly to the plane E1 and essentially in parallel to the mirror plane E3. For example, the plane E2 can also be at an angle between 90° and 45° in relation to the plane E1 and can possibly also be inclined at an arbitrary angle in relation to the mirror plane E3. For example, the planes E1, E2 and the mirror plane E3 are in relation to one another in such a way that the planes do not have any common point together. For example, the planes can also be in relation to one another in such a way that they only intersect in one point.

A perspective view of an exemplary embodiment of the filter holder 412 is shown in FIG. 10. A filter receptacle opening 416 is defined by the circular filter receptacle edge 415 of the filter holder 412, through which filter receptacle opening 416 the respiratory gas can flow toward and away from the filter element 40. In addition, the filter holder 412 has a positioning hole 4011, which is closed on one side. The positioning hole 4011 is used for simplified positioning of the filter holder on the filter receptacle base 411. Furthermore, for example, locking recesses 4022 are formed, using which the filter holder can be locked on the filter receptacle base on corresponding locking projections 4021. A fixed connection between filter receptacle base 411 and filter holder 412 is ensured, for example, by the locking. The filter element 40 is thus also fastened in the filter receptacle 41, thus clamped in, for example, and secured from falling out. If the filter element 40 consists exclusively of the filter material 401, for example, the filter material 401 is pinched or clamped by the locking of the filter holder 412 on the filter receptacle base 411 in such a way that respiratory gas can flow exclusively through the filter material 401. For further securing against the filter element 40 falling out, two webs 414 are additionally arranged on the filter holder 412. For example, these webs 414 are arranged so that they meet or intersect in the center in the filter receptacle opening 416 defined by the filter receptacle edge 415 of the filter holder 412. The webs 414 can moreover also be embodied in any arbitrary other number or in other profiles or can be completely absent. In further exemplary embodiments, for example, three webs 414 extend in parallel to one another. The shape of the filter holder 412, which is primarily defined by the shape of the filter receptacle edge 415, for example, can also vary. Thus, for example, in addition to a circular embodiment, a square or rectangular shape of the filter holder 412 is also possible. In addition, other polygons, oval shapes, and free forms are possible as the geometry of the filter holder 412.

FIG. 11 shows an exemplary embodiment of a filter element 40 for the breathing mask 1 according to the invention, wherein the filter element 40 only consists of filter material 401. The filter material 401 has a positioning hole 4011 for easier positioning on the filter receptacle lug 413 of the filter receptacle base 411. The material of the filter material 401 is to be selected in such a way that germs (e.g., viruses, bacteria, fungi) and/or other microorganisms can be filtered out of the respiratory gas or the respiratory air by the filter material 401 and retained. The filter element 40 shown by way of example can also equipped with one or more filter frames 42 in addition to the filter material 401. Easier insertion and removal of the filter element 40 into or from, respectively, the filter receptacle 41 is simplified by the embodiment having at least one filter frame 42, for example, and a filter holder 412 can be saved depending on the embodiment. For this purpose, for example, the filter frame 42 can also take over functions of the filter holder 412, for example, the locking on or in the filter receptacle base 411. For this purpose, for example, the required locking devices 402 would be attached to the filter frame 42 instead of to the filter holder 412. If the filter receptacle base 411 does not have, for example, a filter receptacle lug 413, a positioning hole for the filter element 40 is thus also not provided, so that no opening results through which respiratory gas can flow without passing the filter material 401. For example, the filter material 401 consists of polypropylene. For example, however, other materials are also conceivable for use as the filter material 401, for example, other plastic fibers arranged in a finely woven manner.

In a further embodiment, the filter material 401 consists, for example, of a gas-permeable container or bag which is filled with a filter material, for example activated carbon.

A further exemplary embodiment of a filter element 40 is shown in a schematic front view in FIG. 12a and the schematic cross section in side view 12b. The filter element 40 has an essentially cuboid shape and consists, for example, of two filter frames 42 between which a filter material 401 is arranged. The filter material 401 is, for example, clamped between the two filter frames 42, wherein the two filter frames 42 are clamped with one another by corresponding locking devices 402. The filter material 401 is corrugated or folded like an accordion in the embodiment shown, by which the filter surface area is increased without enlarging the area of the filter element 40. However, a completely flat embodiment of the filter material 401 is also possible in the arrangement shown in FIG. 12a. The filter frames 42 have webs 414 in each case, which are used, inter alia, to hold the filter material 401 between the filter frames 42 and secure it against slipping out. In addition, a certain additional stability is provided to the filter frame 42 by the webs 414. For the exemplary fastening of the filter element 40 in a filter receptacle 41, a locking device 402 and a handle 404 are attached to the filter element 40, more precisely to one of the filter frames 42. The locking device 402 is embodied so that the counterpart is attached to the filter receptacle 41 (not shown in greater detail), so that the filter element 40 can be locked accordingly via the locking device 402 and is thus solidly seated in the filter frame 41 and secured against falling out. For easy handling, for example, a handle 404 is attached to the filter frame 42 which does not have to coincide with the locking device 402. In the exemplary embodiment shown, the handle 404 is attached together with the locking device 402 on the filter frame 42. This handle 404 can enable, for example, easy changing of the filter element 40. For example, the user can release the filter element 40 from the filter receptacle 41 via grasping the handle 404 and insert a new filter element 40 and lock it in the filter receptacle 41 via the locking device 402 during the use of the breathing mask 1, without removing it. The greatly simplified outline of the cross section of the filter element 40 shown by way of example in FIG. 12b additionally illustrates the location of the filter material 401 relative to the filter frames 42. The exemplary filter element 40 is conceived so that the side having the handle 404 and the locking device 402 is located on the outer side of the breathing mask 1.

The pinching or clamping of the filter material 401 in the filter frames 42, which are connected to one another via locking devices 402, enables, for example, changing of the filter material 401. The two filter frames 42 can also be permanently connected to one another, for example, by adhesive bonding, for example. The filter material 401 can also be permanently connected to the filter frames 42 in this case—also by adhesive bonding, for example—or simply laid between the filter frames 42 and clamped.

Alternatively or also additionally to the locking device 402, for example, guide rails can also be attached to the filter element 40. Together with corresponding guide rails on the filter receptacle 41, an easy change of the filter element 40 can thus also be achieved.

A further exemplary embodiment of the filter receptacle base 411 and of the filter holder 412 is schematically outlined in FIGS. 13a (top view or bottom view) and 13b (side views). The filter receptacle base 411, which is shown by way of example in a top view in FIG. 13a, has a filter receptacle lug 413, which enables easy positioning of the filter element 40 and the filter holder 412. The filter receptacle lug 413 is attached for this purpose, for example, on the intersecting webs 414, wherein the webs can also be positioned differently. For the connection of the filter receptacle base 411 to the filter holder 412 shown by way of example in a bottom view in FIG. 13a, screw threads 403 are arranged on both components. The screw threads 403 are embodied in such a way that they interlock and the filter holder 412 can be screwed solidly into the filter receptacle base 411. The filter element 40, for example, consisting only of the filter material 401, can be laid on the webs 414 and the filter receptacle edge 415 and then solidly pinched or clamped in the filter receptacle base 411 by screwing in the filter holder 412. For easy screwing of the filter holder 412 into the filter receptacle base 411, the filter holder 412 has, for example, a handle 404, as schematically shown in FIG. 13b. The filter holder 412 has, for example, a positioning hole 4011, which is embodied matching with the filter receptacle lug 413, so that easy positioning of the filter holder 412 is enabled. In the illustrated exemplary embodiments of the filter receptacle base 411 and filter holder 412, the screw threads are applied in such a way that they are internal in the filter receptacle base 411 (indicated by the dashed line in FIG. 13b) and are external in the filter holder 412. The screw threads can also be arranged the opposite way, for example, thus on the outside of the filter receptacle base 411 and on the inside of the filter holder 412.

In a further embodiment, for example, the component designated in FIGS. 13a, b as the filter holder 412 is also used as the filter frame 42 for the filter element 40. For this purpose, for example, the filter material 401 is connected to the corresponding component—for example by adhesive bonding. A simple possibility can thus also be provided, for example, to change the filter element 40 during the wearing, thus the use, of the breathing mask 1, for example, also without touching the other components of the breathing mask 1. In further embodiments, constructing the filter element from two or more filter frames 42 is also conceivable. The filter frames 42 can thus also be constructed in accordance with the filter holder 412 and filter receptacle base 411 shown in FIGS. 13a, b, between which the filter material 401 is arranged. The filter element 40 thus constructed can then be pressed, for example, into a filter receptacle 41 embodied as a simple opening and made of a soft or elastomeric plastic. Alternatively, arranging a further screw thread 403 on the filter element 40 and in the filter receptacle 41 would also be conceivable, so that the filter element 40 can be screwed into the filter receptacle.

In addition to the possibilities described on the basis of the Figures for inserting the filter element 40 into the filter receptacle 41 and locking it, all further possibilities for inserting the filter element replaceably in the filter receptacle 41 also correspond to the breathing mask 1 according to the invention. For this purpose, for example, a connection of the filter receptacle base 411 and the filter holder 412 via a type of hinge would also be possible, opposite to which a locking device 402 is located. To change the filter element 40, the filter receptacle 41 can be folded open so that the filter element 40 can be removed and exchanged. After exchanging the filter element 40, the filter receptacle 41 can be folded closed again and locked in such a way that the filter element 40 is solidly seated in the receptacle.

In some exemplary embodiments, the filter receptacle 41 and the filter element 40 are adapted and configured to one another in such a way that it is possible to replace the filter element 40 with few actions. This includes, for example, changing the filter element 40 while wearing the breathing mask 1 without having to touch components of the breathing mask 1 other than the filter element itself. For this purpose, for example, an embodiment of the filter element 40 having a filter frame 42 which has a screw thread 403 is suitable, wherein the filter receptacle 41 also has a corresponding screw thread 403. A further easy replacement option can be represented, for example, by a filter element 40 which does not have locking devices 402 or the like and is pressed, for example, into a filter receptacle 41 produced from a soft plastic and thus can also be pulled out. The breathing mask 1 still presses in a respiratory-gas-tight manner against the face of the user here, for example, due to the head fastening strap 52 and the strap holder 5.

A further exemplary embodiment of the breathing mask 1, consisting of a filter holder 412, a filter material 401, a filter receptacle base 411, and the mask body 2, which is embodied integrally with the mask bead 3, is shown in FIGS. 14 to 20.

FIG. 14a shows by way of example a filter holder 412 in the rear view, thus the side which faces in the direction of the user during use of the mask. The filter holder edge 419 is made essentially triangular, wherein the corners are rounded. Tabs 4023 are arranged on the sides of the filter holder edge 419, which, together with the filter holder edge 419, form the locking recesses 4022. The tabs 4023 are aligned so that they point roughly in the direction of the user, as can be seen in the perspective view in FIGS. 14c and 14d. The tabs 4023 in conjunction with the locking recesses 4022 are used for locking the filter holder 412 on the filter receptacle base 411. In combination with locking projections 4021 of the filter receptacle base 411, the filter holder 412 can thus be locked, for example, via a clip or click mechanism on the breathing mask 1.

A mounting projection 418 is arranged on top—approximately corresponding to the tip of the triangle—on the filter holder edge 419. This mounting projection 418 is designed, for example, so that it can only be assembled in one position and direction with the remaining components of the breathing mask 1. For example, a corresponding groove 21 is formed for this purpose in the mask body 2, into which the mounting projection 418 can be inserted. In some embodiments, the mounting projection 418 and the groove 21 are designed so that the mounting projection 418 can lock in the groove 21 via a clip or click mechanism.

Starting from the filter holder edge 419 in the direction of the center 422 and around the center 422, filter holder webs 426 extend, which form the filter holder openings 427 due to the spacing in relation to one another. The respiratory gas can flow through the filter holder openings 427 during use of the breathing mask 1. For example, starting from the corners of the filter holder edge 419, three filter holder webs 426 extend to the center 422. These three filter holder webs 426 are connected to one another by a triangular arrangement of further filter holder webs 426. Moreover, for example, starting from two sides of the filter holder edge 419, two further filter holder webs 426 extend in the direction of the center 422, wherein these merge into the triangular arrangement of the webs.

A pressing edge 423 is formed on the filter holder edge 419 and on the filter holder webs 426. With respect to the filter holder edge 419 in the perspective shown in FIG. 14a, for example, the pressing edge 423 extends without interruption on the inner side (closer to the center 422) of the filter holder edge 419, so that respiratory gas can only flow through the filter material 401 in the completely assembled breathing mask 1. For this purpose, the pressing edge 423 is designed so that it presses on or partially into the filter material 401. The pressing edge 423 is thus also used, for example, for additional fixing of the filter material 401 between filter holder 412 and filter receptacle 413. The filter holder 412 is slightly bulging, for example, wherein the pressing edge 423 establishes a plane and the filter holder webs 426 and the filter holder edge 419 form a bulge in the lower region, thus opposite the mounting projection 418. The height of the pressing edge 423, which starts from the filter holder edge 419 and the filter holder webs 423, thus varies.

FIG. 14b shows the exemplary filter holder 412 from FIG. 14a in a front view. As in FIG. 14a, it can also be seen in the front view of FIG. 14b that the filter holder frame is formed essentially triangularly having rounded corners. Starting from the filter holder edge 419, the filter holder webs 426, which also form the filter holder openings 427 by the spacing in relation to one another and to the filter holder edge 419, extend toward the center 422. Moreover, the tabs 4023 which are used for locking the filter holder 412 on the filter receptacle base 411 are arranged to the sides of the filter holder edge 419.

In some embodiments, the filter holder 412 is produced from a dimensionally stable plastic. A production from deformable or elastomeric plastics, such as silicones, is also conceivable. The filter holder 412 is preferably produced integrally, for example, by injection molding.

An exemplary embodiment of the filter receptacle base 411 is schematically shown in FIGS. 15a-d and 16a, b in various perspectives and details. Together with the filter holder 412, the filter receptacle base forms the filter frame 42, which can accommodate the filter material 401.

Matching with the shape of the filter holder 412 or the pressing edge 423, the filter receptacle base 411 is made trapezoidal, as the front view (faces away from the user) in FIG. 15a shows. The filter receptacle edge 425 essentially encloses the filter receptacle opening 416 here. Moreover, the filter receptacle webs 414 extend from the filter receptacle edge 425 into the filter receptacle opening 416 and accordingly divide it into multiple smaller openings. On the filter receptacle webs 414 are arranged holding tips 417, which are formed so that they press onto and/or into the filter material 401 without piercing it. An enlarged schematic view of the holding tips 417 is shown in FIG. 15d, wherein the detail corresponds to detail D1 from FIG. 15c. The holding tips 417 are, for example, conical protrusions on the filter receptacle webs 414, wherein the tip is flattened. In addition, the holding tips 417 can also have various other shapes, inter alia, also because of the production of the filter receptacle base 411, for example, by injection molding. For example, fixing of the filter material 401 in the filter receptacle base 411 or the filter frame 42 is achieved by the holding tips. A pressing edge 424, which is slightly elevated in relation to the filter receptacle edge 425, extends along the filter receptacle edge 425 in the region of the filter receptacle opening 416. For example, the pressing edge 424 has a height of 0.1 mm to 2.0 mm, preferably between 0.3 mm and 0.8 mm. The pressing edge 424 is pressed onto the filter material 401 during the assembly of the breathing mask 1, so that respiratory gas only flows through the filter material 401 through the filter receptacle opening 416 and to the user through the filter holder openings 427. To achieve a taller overlap region between pressing edge 424 and the filter material 401, the pressing edge 424 is made crowned, for example, thus bulging somewhat into the filter receptacle opening 416. For example, the filter receptacle webs 414 of the filter receptacle base 411 do not have a pressing edge, like, for example, the exemplary embodiment of the filter holder webs 426 according to FIG. 14a. Additionally or alternatively to the exemplary holding tips 417, however, additional pressing edges can also be formed on the filter receptacle webs 414.

Locking projections 4021 are arranged on the outer sides of the filter receptacle edge 425 of the filter receptacle base 411. These locking projections 4021 are guided during the assembly of the breathing mask 1, for example, through the mounting openings 4024 of the mask body 2 and are used together with the tab 4023 and the locking recesses 4022 for locking the filter holder 412 on the filter receptacle base 411. As can be seen in the perspective view of the filter receptacle base 411 in FIG. 15b, the locking projections 4021 are angled slightly in the direction of the rear side, thus in the direction of the user. If, for example, a tab 4023 is guided over the locking projections 4021, the tab 4023 thus hooks under the locking projections 4021. The filter holder 412 can thus be locked securely on the filter receptacle base 411.

For simplified mounting and to avoid assembling the breathing mask 1 incorrectly, a mounting projection 420 is arranged on the filter receptacle edge 425. When the breathing mask 1 is assembled, the mounting projection 420 extends below the lower edge of the filter material 401 and the pressing edge 423 of the filter holder 412. With respect to the mask body 2, a recess 22 is formed there which can accommodate the mounting projection 420. For example, the mounting projection 420 can also be used to align the filter material 401 in that the lower edge of the filter material 401 is placed on the mounting projection 420 before the filter holder 412 is pressed onto the filter receptacle base 411 and locked. A matching alignment of the components in relation to one another is moreover promoted by the essentially triangular or trapezoidal formation of the filter holder 412, the filter receptacle base 411, and the filter material 401.

Starting from the filter receptacle edge 425, as can be seen in FIG. 15b, a mounting edge 428 extends on the rear side (direction of the user) of the filter receptacle base 411, on which edge two mounting ribs 421 are in turn formed. The mounting edge 428 having the mounting ribs 421 is inserted into the central opening of the mask body 2 for assembly of the breathing mask 1 and is used, for example, for simplified and correctly oriented insertion into the mask body 2. In addition, the filter receptacle base 411 is held in the mask body 2 by the locking projections 4021, which are inserted through the mounting openings 4024 of the mask body 2.

FIGS. 16a and 16b show an exemplary embodiment of the filter receptacle base 411 in a side view. Starting from the filter base edge 425, the pressing edge 424 and the mounting projection 420 are raised on one side. On the other side of the filter receptacle base 411, the mounting edge 428 extends starting from the filter base edge 425.

Details of the mask bead 3 of the exemplary embodiment of the breathing mask 1 are shown in FIGS. 17a and 17b. FIG. 17a shows the nasal bridge region 33 of the mask bead 3. It can be seen that the material thickness is substantially constant from the transition 344 up to the edge 342 of the sealing lip. For example, the material thickness of the mask bead 3 in the region of the nasal bridge region 33 is between 0.1 mm and 0.8 mm, preferably between 0.3 mm and 0.5 mm. To ensure a stable seat of the breathing mask 1, the material thickness in the base region 32 of the mask bead 3 coming from the transition 344 is initially greater and decreases in the direction of the edge 342 of the mask bead 3. In the region of the transition 344, the material thickness is, for example, between 0.5 mm and 2.0 mm, preferably between 0.7 mm and 1.5 mm. Toward the edge 342, the material thickness is reduced to between 0.1 mm and 0.8 mm. Similar profiles of the material thicknesses can also be formed, for example, in the side regions 31 of the mask bead 3. Overall, the material thickness of the mask bead 3 is dependent on the region of the mask bead 3 and also on which point of the facial skin of the user the respective region rests. The material thickness is thus to be selected as less in the region of more sensitive points of the facial skin, while at other points a greater material thickness can be selected to stabilize the mask bead 3.

The mask body 2 is, for example, produced integrally with the mask bead 3, as shown in FIGS. 18a-c. For example, the mask body 2 is manufactured in one piece with the mask body 3 and from one material. A silicone, for example, a liquid silicone rubber, is preferably used for this purpose. The Shore hardness of the material used is, for example, between 40 and 80 Shore A, wherein a maximum elasticity between 50% and 600% can be achieved. In particular for the mask body 2, other materials are also usable, for example, elastic or elastomeric plastics or dimensionally stable plastics such as polycarbonate, polystyrene, polyamide, etc. In the mask body 2 and the mask bead 3, it is to be ensured here that they are not permeable to respiratory gas—with the exception of the opening 24, 30 provided for this purpose. Starting from the transition 344 from the mask body 2 to the mask bead 3, for example, the material thickness increases, so that the mask body 2 largely has a greater material thickness than the mask bead 3. It is also to be noted here that the transition 344 can also be made continuous, so that no clear boundary is recognizable between mask body 2 and mask bead 3. The material thickness of the mask body 2 is, for example, between 1.5 mm and 5 mm, preferably between 1.5 mm and 3 mm. In some regions, in particular in the region of the opening 24 of the mask body 2, the resulting material thickness can be less at points, for example to enable mounting of components such as the filter receptacle base 411 or the filter holder 412.

The ratio of the distance between the corner points 311 and 314 to the distance between the corner points 312 and 313 is between 1:2 and 1:8.

In the exemplary embodiment shown of the mask body 2 having the mask bead 3, the strap holders 5 are also integrally connected to the mask body 2. For example, the strap holder 5 consists of a fastening projection 50 on the outer side of the mask body 2, wherein the fastening projection 50 in turn has two feedthrough openings 51. The number of feedthrough openings 51 and/or fastening projections 50 can vary here and can be adapted in accordance with the intended number of fastening straps 52. The feedthrough openings 51 are configured, for example, so that a head fastening strap 52 can be guided through the feedthrough openings 51. For example, protrusions 521 are formed on the head fastening strap 52, which are used for fixing the head fastening strap 52 in the strap holder 5. For this purpose, the fastening projection 50 is made of an elastic material, for example, so that the feedthrough openings 51 can be made smaller in height and width than the protrusions 521. Due to the elasticity of the fastening projection 50, the protrusions 521 can be guided through the feedthrough openings 51 with application of force. To guide the protrusions 521 in the opposite direction through the feedthrough openings 51 again, a certain application of force is also necessary, so that a corresponding fixation of the head fastening strap 52 in the strap holder results.

Mounting openings 4024 are formed in the side walls 25 of the mask body 2 in the region of the opening 24, which is used for mounting the filter frame 42, consisting of filter holder 412, filter receptacle base 411, and filter material 401. The locking projections 4021 of the filter receptacle base 411 are guided through these mounting openings 4024, so that they can be fixed/locked in the mask body 2. In the exemplary embodiment from FIGS. 18a-c, a mounting edge 23 is formed in the region of the opening 24 which is adapted to the dimensions of the mounting edge 428 of the filter receptacle base 411, for example, to assist correct mounting of the filter receptacle base 411 in the mask body 2. The mounting edge 23 protrudes here from the edge 26 into the opening 24. For example, the dimensions of the mounting edge 23 are slightly smaller, so that the filter receptacle base 411 can be pressed into the opening 24 on the inner side of the mounting edge 23 and held there. The slightly smaller dimensions of the mounting edge 23 are also used, for example, for the respiratory-gas-tight enclosure of the filter receptacle base 411. The recess 22 in the region of the opening 24 is formed so that the recess 22 can accommodate the mounting projection 420 of the filter receptacle base 411. Moreover, a groove 21, which can accommodate the mounting projection 418 of the filter holder 412, is formed in the region of the opening 24 for correct positioning of the filter holder 412. The edge 26 is formed toward the opening 24 so that the filter holder 412 can be inserted in a precisely fitted manner and enclosed in a respiratory-gas-tight manner, so that respiratory gas on the side of the opening 24 can only flow through the filter holder openings 427, the filter receptacle openings 416, and the filter material 401 into the interior of the breathing mask 1.

The exemplary embodiment of the mask bead 3, which is integrally connected to the mask body 2, largely corresponds to the exemplary embodiment of the mask bead 3 described in FIG. 5. While the material thicknesses of the mask bead 3 are designed, for example, for wearing comfort, sealing, and wearing stability, the material thicknesses in the region of the mask body 2 are comparatively greater to ensure general mechanical stability of the mask body 2 and to counteract undesired deformations, which could result in leaks.

An exemplary embodiment of the assembled breathing mask 1 is shown in FIGS. 19a and 19b. The mask bead 3 merges into the mask body 2. The filter receptacle base 411 is inserted into the mask body 2, of which filter receptacle base 411 only the locking projections 4021 are visible in the perspective shown. The filter material 401, which is fixed by the filter holder 412, is laid on the filter receptacle base 411. The filter holder 412 is fixed with the aid of the tab(s) 4023 via the locking projections 4021 on the filter receptacle base 411 and on the mask body 2. Respiratory gas can only flow from the side of the mask body 2 through the filter material 401 and the filter holder openings 427 into the interior of the breathing mask 1 when the breathing mask 1 presses in a respiratory-gas-tight manner with the mask bead 3 on the facial skin of the user. In FIG. 19b it is shown by way of example in detail how the tab 4023 is clamped behind the locking projections 4021 and thus locks the filter holder 412.

The breathing mask 1 in the assembled state, without straps, has a maximum width (cf. B in FIG. 18b) at the widest point between 75 mm and 105 mm. The maximum height (cf. H in FIG. 18c) of the breathing mask 1 is between 80 mm and 130 mm, wherein the maximum depth of the breathing mask 1 is between 50 mm and 90 mm.

In addition, the structure of the breathing mask 1 is clarified by the exploded view of the breathing mask 1 in FIG. 20. The filter receptacle base 411 is inserted into the mask body 2. The filter material 401, which is fixed between the filter receptacle base 411 and the filter holder 412 by the pressing edges 423, 424 and the holding tips 417, is arranged on the filter receptacle base 411. The filter holder 412 is locked with the aid of the tab 4023 on the locking projections 4021, which are guided through the mounting openings 4024. For simplified alignment, on the one hand, it is provided that the mounting projection 420 is accommodated by the recess 22 and, on the other hand, it is provided that the mounting projection 418 is inserted into the groove 21 of the mask body 2.

For example, the mask body 2 is made of an elastic material, for example, an elastomeric plastic such as silicone, and in dimensions such that the filter receptacle base 411 and the filter holder 412 have to be pressed at least partially into the mask body 2, that is to say the mask body is somewhat smaller. A respiratory-gas-tight fixation of the filter receptacle base 411 and the filter holder 412 can thus be ensured, for example.

The head fastening strap 52, which is guided through the feedthrough openings 52 of the strap holder 5, has protrusions 521 in some embodiments, which are used for fixing—inter alia therefore for the prevention of an adjustment. Furthermore, openings 522 are formed at the ends of the head fastening strap 51 which can accommodate the holding clip 54. The holding clip 54 has for this purpose a holding shaft 542 which is formed on a clip body 543 and can be accommodated by the opening 522. To prevent the holding shaft 542 from slipping out, a holding safeguard 541 is formed on the holding shaft 542, which is significantly larger in circumference than the opening 522. The head fastening strap 52 is preferably manufactured from an elastic material, so that the opening 522 for mounting the holding clip 54 on the head fastening strap 52 can at least temporarily be expanded enough that the holding safeguard 541 can be guided through the opening. The clip body 543 is made C-shaped, for example, and can be slipped over the head fastening strap 52, for example, between two protrusions 521. The holding clip 54 thus fulfills at least two tasks, on the one hand, the holding clip helps in the fixing of the head fastening strap 52 and secures against inadvertent widening of the straps, which can result in a looser seat of the breathing mask 1. On the other hand, the loose end of the head fastening strap 52 can be fixed by the holding clip 54 to avoid annoying movements of the end of the head fastening strap 52. For example, the holding clip 54 is made of a dimensionally stable plastic, but other materials, for example, elastic materials, are also conceivable for the holding clip.

### LIST OF REFERENCE SIGNS

1 breathing mask
2 mask body
3 mask bead
4 filter device
5 strap holder
21 groove
22 recess
23 mounting edge
24 opening
25 side wall
26 edge
30 receptacle opening
31 side region
32 base region
33 nasal bridge region
34 contact region
35 mask fitting
40 filter element
41 filter receptacle
42 filter frame
50 fastening projection
51 feedthrough opening
52 head fastening strap
53 loop
54 holding clip
311 corner point
312 corner point
313 corner point
314 corner point
341 sealing lip
342 edge of the sealing lip
343 notch
344 transition
401 filter material
402 locking device
403 screw thread
404 handle
411 filter receptacle base
412 filter holder
413 filter receptacle lug
414 filter receptacle web
415 filter receptacle edge
416 filter receptacle opening
417 holder tip
418 mounting projection
419 filter holder edge
420 mounting projection
421 spacer rib
422 center
423 pressing edge
424 pressing edge
425 filter base edge
426 filter holder web
427 filter holder opening
428 mounting edge
521 protrusion
522 opening
541 holding safeguard
542 holding shaft
543 clip body
4011 positioning hole
4021 locking projection
4022 locking recess
4023 tab
4024 mounting opening
A direction toward the user
D1 detail
D2 detail
E1 plane
E2 plane
E3 mirror plane
L1 connecting line
L2 connecting line
p1 point on contact region
p1′ point on contact region
p2 mirror point on contact region
p2′ mirror point on contact region

1.-54. (canceled)

55. A breathing mask, wherein the breathing mask comprises a mask body, a mask bead, at least one strap holder, and at least one filter device, the mask bead, the at least one strap holder and the at least one filter device being connected to the mask body and/or are part of the mask body, wherein the breathing mask as a whole encloses a nose and mouth of a user, the mask bead partially delimiting a receiving opening for the nose and mouth of the user, wherein the at least one filter device comprises at least one filter receptacle and at least one filter element, wherein the mask bead has a bearing region embodied as a sealing lip and is configured so that the breathing mask bears against facial skin around at least the nose and mouth of the user with the sealing lip during use and provides a seal in an essentially respiratory-gas-tight manner, and wherein the filter device is at least partially replaceable and respiratory gas can at least partially flow through it, the filter element comprising at least one filter material.

56. The breathing mask of claim 55, wherein the mask body, the filter receptacle, and the mask bead define a respiratory gas chamber, which is essentially respiratory-gas-tight during use and a respiratory gas flow from and/or to the mouth and nose of the user is thus exclusively possible through the filter device.

57. The breathing mask of claim 55, wherein the mask bead comprises a nasal bridge region, a base region, two side regions, a mask fitting, and a contact region, the nasal bridge region and the base region being spatially separated from one another by the side regions and the nasal bridge region and the base region being each connected to both side regions.

58. The breathing mask of claim 57, wherein the sealing lip, starting from the side regions, the nasal bridge region, and the base region, describes a curve in cross section and an edge of the sealing lip determines a size of an area of the receptacle opening.

59. The breathing mask of claim 57, wherein a wall thickness in a region of the side regions is greater than a wall thickness of the sealing lip.

60. The breathing mask of claim 57, wherein a wall thickness of the mask bead decreases continuously from the side regions to the sealing lip.

61. The breathing mask of claim 57, wherein a wall thickness of the mask bead is less in the nasal bridge region and base region than in the side regions, the wall thickness increasing in the base region toward the side regions, so that a transition region results which is arranged at least partially in the base region, wherein the wall thickness in the nasal bridge region and the base region at least corresponds to the wall thickness of the sealing lip.

62. The breathing mask of claim 57, wherein the bearing region of the mask bead has corner points, which are used for aligning the breathing mask on a face, at the transitions from the nasal bridge region a to the side region and from the base region a to the side region.

63. The breathing mask of claim 57, wherein the sealing lip, starting from the side regions, the nasal bridge region, and the base region, protrudes in an arc into the receptacle opening of the mask bead.

64. The breathing mask of claim 55, wherein the filter receptacle is formed as a surface, thus has a significantly greater dimension in a direction x2 and a direction y2 perpendicular thereto than in a direction z2 perpendicular to a plane E2 spanned by x2 and y2.

65. The breathing mask of claim 55, wherein a ratio of an area of the receptacle opening of the mask bead to an area of the filter device through which flow occurs is from 2:1 to 1:2, an area of the filter device through which respiratory gas flows being at least 16 cm².

66. The breathing mask of claim 56, wherein the respiratory gas chamber and the filter device are at least dimensioned in such a way that it is possible to wash out CO₂.

67. The breathing mask of claim 55, wherein the filter device is arranged in such a way that a substantially unobstructed flow between mouth/nose and filter device is enabled.

68. The breathing mask of claim 57, wherein the filter receptacle defines a plane E2 and the mask bead defines a plane E1, wherein the mask bead is constructed essentially mirror symmetrically, a mirror plane E3 extending through the base region and the nasal bridge region, but not through the side regions, and wherein the plane E1 intersects the mirror plane E3 and is spanned by at least two connecting lines (L1, L2), the connecting lines (L1, L2) each extending between a point (p1, p2) on an outer side of the bearing region facing toward a face of the user and an associated mirror point (p1′, p2′).

69. The breathing mask of claim 68, wherein the planes E1 and E2 extend essentially in parallel to one another and are spaced apart from one another.

70. The breathing mask of claim 68, wherein the planes E1 and E2 extend essentially perpendicular to the mirror plane E3.

71. The breathing mask of claim 68, wherein the plane E1 is perpendicular to the mirror plane E3 and the plane E2 is inclined at an angle of from 0° to 15° in relation to the plane E1 and/or the mirror plane E3.

72. The breathing mask of claim 68, wherein the planes E1 and E2 are perpendicular or at an angle of 90° to 45° to one another.

73. The breathing mask of claim 55, wherein the filter material is configured and designed to filter germs and other microorganisms out of air and/or other gases and to retain them on and/or in the filter material.

74. A filter element for a breathing mask, wherein the filter element comprises at least one filter material and at least one filter frame, wherein the filter material is pinched or clamped in the filter frame or is solidly connected to the filter frame and is configured to filter germs and/or other microorganisms out of air and/or other gases and to retain them on and/or in the filter material, the area of the filter element through which flow occurs being from 16 cm² to twice an area of a receptacle opening of the breathing mask defined by an edge of a sealing lip of the breathing mask.
